(19) United States
(12) Patent Application Publication
(10) Pub. No.: US 2016/0029377 A1
(43) Pub. Date: Jan. 28, 2016

(54) WIRELESS TERMINAL STATION AND BASE STATION

(71) Applicant: SHARP KABUSHIKI KAISHA, Osaka-shi, Osaka (JP)

(72) Inventors: Yoko MASUDA, Osaka-shi, Osaka (JP); Hideo NAMBA, Osaka-shi, Osaka (JP); Minoru KUBOTA, Osaka-shi, Osaka (JP)

(73) Assignee: SHARP KABUSHIKI KAISHA, Osaka-shi, Osaka (JP)

(21) Appl. No.: 14/775,295

(22) PCT Filed: Feb. 28, 2014
(86) PCT No.: PCT/JP2014/055143

§ 371 Date: Sep. 11, 2015

(30) Foreign Application Priority Data
Mar. 12, 2013 (JP) 2013-049128

(51) Int. Cl. H04W 72/04; H04L 12/875; H04W 76/02

(52) U.S. Cl. CPC H04W 72/0446; H04W 76/021; H04L 47/56; H04W 88/08

(57) ABSTRACT

Demodulation is effectivley performed that uses an MMSE adaptive array which uses a guard section of a signal that uses a cyclic prefix. According the present invention, there is provided a wireless terminal station that is applied to a wireless communication system which is made up of multiple wireless terminal stations and a base station, the wireless terminal station including: a delay time setting module 123 that sets a delay time based on a transmission timing identification number; and a transmission module 108 that, in a case where any other wireless terminal station starts transmission within a predetermined time after all communication within the wireless communication system is ended, starts transmission after the delay time has elapsed from a point in time at which the transmission has started.

### TECHNICAL FIELD

The present invention relates to a wireless terminal station and a base station that are applied to a wireless communication system that is made up of multiple wireless terminal stations and a base station.

### BACKGROUND ART

In IEEE 802.11 specifications (NPL 1), Carrier Sense Multiple Access with Collision Avoidance (CSMA/CA) is employed as an access control function for sharing the same wireless channel among multiple terminals. In a Distributed Coordination Function (DCF), with exchange of CSMA/CA and Request To Send/Clear To Send (RTS/CTS), transmission timing of collision between wireless terminal stations present within a cell is avoided.

The CSMA/CA among types of DCF control that are adopted in IEEE 802.11 specifications will be described below. The CSMA/CA among types of DCF control that are used in IEEE 802.11 is access control that results from combining control through carrier sensing and control through back-off. With the control through carrier sensing, when a transmission request occurs, the wireless terminal station present within the cell performs carrier sensing and checks on a state where a wireless channel is used.

In a case where a transmission by a different wireless station is confirmed (in a case where a channel is busy), transmission waiting is implemented and thus collision is avoided if possible. With the control through back-off, after the channel changes from a busy state to an idle state, the carrier sensing continues for a DCF Inter Frame Space (DIFS) time, and performs the carrier sensing for a time that is referred to as continuous back-off time. In a case where a back-off time channel is not busy, with the CSMA/CA among the types of DCF control that are used in IEEE 802.11, the wireless terminal station starts to transmission data.

The back-off time is determined based on a random number value Random ( ) that occurs within a range of Contention Window (CW) that is a predetermined value starting from 0, and on a slot time. A method of determining the back-off time is expressed in Equation 1.

[Math. 1]

Back-off time=Random ( )×slot time Equation 1

To be more precise, the CSMA/CA among the types of DCF control that are used in IEEE 802.11 is access control with which the transmission is started after a state where the channel is idle is confirmed through the carrier sensing during “the DIFS time+the back-off time”. The scheme described above is referred to as a DCF in the related art. Furthermore, “the DIFS time+the back-off time” is referred to as a DCF control time. In the multiple wireless terminal stations present within the cell, due to an influence of a distance between terminals and of an obstacle, a signal of each of the terminals does not arrive, and a state where the carrier sensing does not function occurs. This problem is referred to as a hidden terminal problem.

Furthermore, a Minimum Mean Square Error (MMSE) adaptive array technology that, in a reception station, uses a guard section of a signal that uses a cyclic prefix, such as OFDM, as a scheme for suppressing an interference wave has attracted attention. With this technology, a system is available that operates an MMSE adaptive array, using any of two guard sections as a reference signal, based on the fact that a head GI (guard interval) that is a guard section which is added to the head of a valid symbol of a signal that uses the cyclic prefix and a tail GI that is a guard section which is the tail of the valid symbol are the same (NPL 2). In a case where timings that reach a base station are different between a desired wave and an interference wave, this system is effective. Particularly, the system is more effective because a difference between arrival points at which the desired wave and the interference wave reach the base station, respectively, is a guard interval length or above. One characteristic of the system is that the system performs blind processing that does not need a reference signal in a normal MMSE adaptive array.

### CITATION LIST

### Non Patent Literature

NPL 1: IEEE Std 802.11-2007

NPL 2: Y. Inami, N. Kikuma, H. Hirayama, and K. Sakakibara, “Study on Improvement of Convergence Characteristics of the Blind MMSE Adaptive Array in OFDM Transmission System” Proc. Of ISAP 2008, October, 2008

### SUMMARY OF INVENTION

### Technical Problem

In a case where the number of wireless terminal stations is extremely high, or in an environment in which the number of hidden terminals is great, non-exclusive communication that uses CSMA/CA that has low efficiency. In this environment, communication efficiency can be improved by allowing the wireless terminal station to freely perform transmission and by performing demodulation that uses a blind processing technology at the receiving side. As described above, the MMSE adaptive array technology that uses a guard section in a signal which uses a cyclic prefix is effective because a timing at which a reception station starts to receive a desired wave and a timing at which the reception station starts to receive an interference wave are different from each other. For this reason, when the wireless terminal station freely performs the transmission, there is a problem that a case can occur where the MMSE adaptive array which uses the guard section in the signal that uses the cyclic prefix does not function effectively.

The present invention, which is made in view of this situation, is to provide a wireless terminal station and a base station that are capable of effectively performing demodulation with an MMSE adaptive array which uses a guard section of a signal that uses a cyclic prefix.

### Solution to Problem

In order to achieve the above-mentioned object, the present invention provides the following means. That is, a wireless terminal station of the present invention that is applied to a wireless communication system which is made up of multiple wireless terminal stations and a base station, the wireless terminal station includes a delay time setting module that sets a delay time based on a transmission timing identification number; and a transmission module that starts transmission after the delay time has elapsed from a point in time at which transmission has started in a case where any other wireless terminal station starts the transmission within a predetermined time after all communication within the wireless communication system is ended.

### Advantageous Effects of Invention

According to the present invention, because data transmission timing varies from one wireless terminal to another, it is possible to effectively perform demodulation with an MMSE adaptive array that uses a guard section of a signal which uses a cyclic prefix.

### BRIEF DESCRIPTION OF DRAWINGS

FIG. 1 is a diagram illustrating a schematic configuration of a wireless communication system according to a first embodiment.

FIG. 2 is a diagram illustrating one example of a timing chart for a period of time from when with transmission timing control, the wireless terminal stations 1 to 4 transmit a transmission frame to a base station 5 to when the base station 5 transmits an acknowledgement (ACK) to each of the wireless terminal stations 1 to 4.

FIG. 3 is a functional block diagram illustrating one configuration example of a wireless terminal station 1 according to the present embodiment.

FIG. 4 is a flowchart illustrating an operation in which the wireless terminal station 1 performs association establishment.

FIG. 5 is a flowchart for a period of time from when a transmission request occurs to when the wireless terminal station 1 receives the ACK.

FIG. 6 is a functional block diagram illustrating one configuration example of a base station 5 according to the present embodiment.

FIG. 7A is a timing chart of an OFDM symbol. [FIG. 7B is a timing chart that results when an LTF that is a channel estimation field in IEEE 802.11 is received.

FIG. 8 is one example of a functional block of a beam generation module 166.

FIG. 9 is a flowchart for a period of time from when the base station 5 receives a signal to when the base station 5 transmits an ACK.

FIG. 10 is a flowchart for a period of time from when the base station 5 receives an association request to when the base station 5 transmits an association response.

FIG. 11 is a diagram illustrating a schematic configuration of a wireless communication system according to a second embodiment.

FIG. 12 is a diagram illustrating one example of a timing chart for a period of time from when with the transmission timing control, wireless terminal stations 301 to 304 transmit the transmission frame to a base station 305 and to when the base station 305 transmits an ACK to each of the wireless terminal stations 1 to 4.

FIG. 13 is a functional block diagram illustrating one configuration example of a wireless terminal station 301 according to the present embodiment.

FIG. 14 is a flowchart for a period of time from when a signal is received from a base station 306 to when a type of reception signal frame is determined and thus processing is performed.

FIG. 15 is a flowchart for a period of time from when the wireless terminal station 301 transmits data to when the wireless terminal station 301 receives the ACK.

FIG. 16 is a functional block diagram illustrating one configuration example of the base station 305 according to the present embodiment.

FIG. 17 is a flowchart for a period of time from when the base station 305 receives a signal to when the base station 305 starts demodulation of data and transmits the ACK.

FIG. 18 is a flowchart illustrating that the base station 305 transmits a beacon.

FIG. 19 is a flowchart for a period of time from when a group ID is generated to when a group ID management frame is transmitted.

### DESCRIPTION OF EMBODIMENTS

According to an embodiment of the present invention, multiple wireless terminal stations that are included in a system perform communication with control that makes determination in such a manner that data transmission starting timings of the wireless terminal stations are different from each other according to identification information on a terminal that is assigned to each of the wireless terminal stations, such as an association Identifier (AID), a medium access control (MAC) address, and a group ID. The embodiment of the present invention will be described in detail below referring to the drawings. Moreover, a portion that is not disclosed in a description of the present embodiment is assumed to be fundamentally based on IEEE 802.11 and IEEE 802.11a specifications.

### First Embodiment

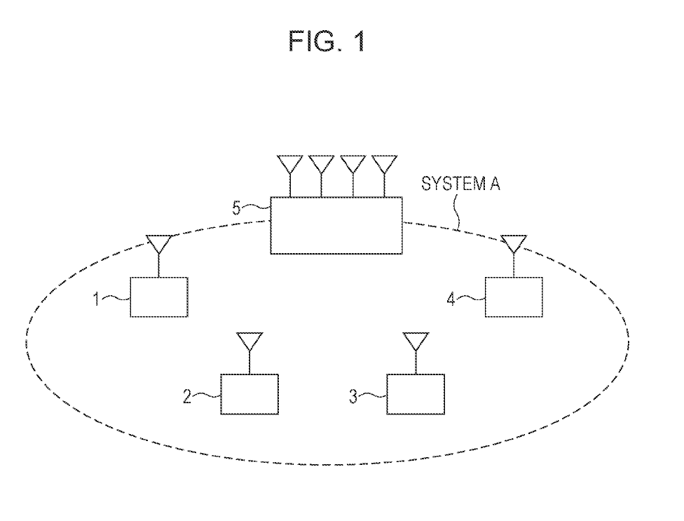

FIG. 1 is a diagram illustrating a schematic configuration of a wireless communication system according to the present embodiment. According to the present embodiment, a case is described where an OFDM signal to which a guard interval is added is used as a signal that uses a cyclic prefix. However, the signal that uses the cyclic prefix is not limited to the OFDM signal.

As illustrated in FIG. 1, a wireless communication system A according to the present embodiment has a base station 5 that includes four antennas and four wireless terminal stations 1 to 4, each of which has one antenna.

In the base station 5 and the four wireless terminal stations 1 to 4, a wireless signal is assumed to reach all communication stations that are included in the system. In the wireless communication system A that is illustrated in FIG. 1, transmission frequencies and reception frequencies of all the communication stations that are included in the system are equal. Moreover, according to the present embodiment, for brief description, the number of antennas that are to be included in each of the four wireless terminal stations 1 to 4 is assumed to be 1, but multiple antennas may be provided. In the same manner, the number of antennas that are to be included in the base station 5 may be changed.

According to the present embodiment, in CSMA/CA control in DCF control that does not use RTS/CTS exchange, timing control of transmission by each of the wireless terminal stations 1 to 4 is described. According to the present embodiment, one example of a method is described in which, in a case where after the DCF control starts, a DCF control time channel is not busy, and, in a case where after the DCF control is ended, transmission of a transmission frame starts and, on the other hand, a different wireless terminal station starts transmission during a DCF control time, the wireless terminal stations 1 to 4 start to transmit the transmission frame when a predetermined delay time elapses from the timing at which the different wireless terminal station starts the transmission. However, the predetermined delay time is a time that is determined by a transmission timing identification number that is obtained from the terminal identification information (the AID, or the MAC address, or the like) that is assigned to each of the wireless terminal stations. To be more precise, the wireless terminal station that is assigned the same transmission timing identification number has the same delay time. According to the present embodiment, a method is described in which as one example, the transmission timing identification number is determined based on the AID.

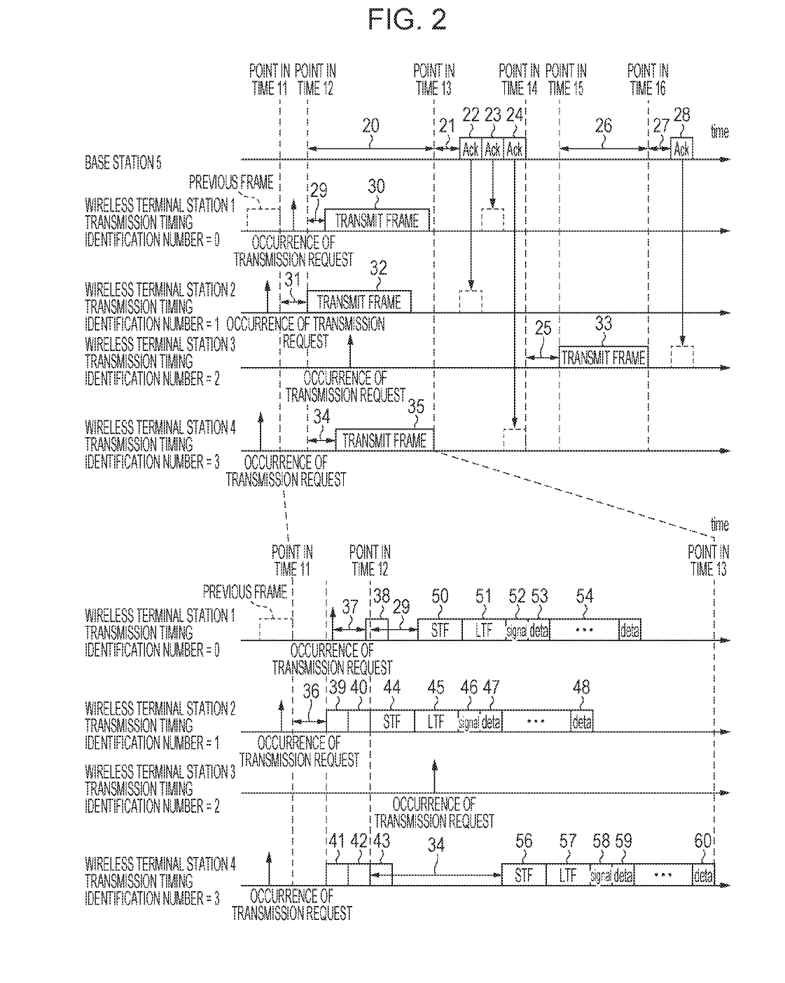

FIG. 2 is a diagram illustrating one example of a timing chart for a period of time from when, with the transmission timing control, the wireless terminal stations 1 to 4 in FIG. 1 transmit the transmission frame to the base station 5 and to when the base station 5 transmits an ACK to each of the wireless terminal stations 1 to 4. Furthermore, FIG. 2 is configured from an entire timing chart and a timing chart that results from enlarging a period of time from a point in time 11 to a point in time 13 that is a portion of the entire timing chart. According to the present embodiment, before the transmission timing control of the transmission frame, each of the wireless terminal stations 1 to 4 is assigned the transmission timing identification number from the AID, and a different delay time is set for every transmission timing identification number. In one example in FIG. 2, a wireless terminal station 1 is assigned a transmission timing identification number of 0, a wireless terminal station 2 is assigned a transmission timing identification number of 1, a wireless terminal station 3 is assigned a transmission timing identification number of 2, and a wireless terminal station 4 is assigned a transmission timing identification number of 3. A method of assigning the transmission timing identification number will be described below. Furthermore, a method of setting the delay time will be described below as well.

First, the entire timing chart will be described. Each transmission request of the wireless terminal stations 2 and 4 occurs before the point in time 11 when they are in a channel-busy state. Each of the wireless terminal stations 2 and 4 starts the DCF control from the point in time 11 from which a channel changes from a busy state to an idle state. However, the DCF control here is fundamentally the same as the DCF control in IEEE 802.11, and transmission waiting is implemented while carrier sensing is performed during the DCF control time (DIFS time+back-off time).

In one example in FIG. 2, the channel is in the idle state during a DCF control time 31 for the wireless terminal station 2. For this reason, the wireless terminal station 2 starts to transmit a transmission frame 32 after the DCF control is performed. Furthermore, a channel becomes in a busy state at a point in time 12 at which the wireless terminal station 4 is in the middle of performing the DCF control. For this reason, the wireless terminal station 4 interrupts the DCF control, and starts to transmit a transmission frame 35 after a delay time 34 that is assigned to the wireless terminal station 4 elapses from the point in time 12.

Next, the wireless terminal station 1 will be described. In the wireless terminal station 1, the transmission request occurs during a period of time from the point in time 11 to the point in time 12 during which the channel is in the idle state. For this reason, the wireless terminal station 1 starts the DCF control immediately after the transmission request occurs. However, as is the case with the wireless terminal station 4, a channel becomes in the busy state at the point in time 12 at which the wireless terminal station 1 is in the middle of performing the DCF control. For this reason, the wireless terminal station 1 starts to transmit a transmission frame 30 after a delay time 29 that is assigned to a transmission terminal station 1 elapses from the point in time 12. The point in time 13 is a timing at which each of the wireless terminal stations 1, 2, and 4 stops the transmission.

The base station 5 receives a signal from the wireless terminal stations 1, 2, and 4 during a period of time 20, and successively transmits an ACK 22 that is an ACK to the wireless terminal station 2, an ACK 23 that is an ACK to the wireless terminal station 1, and an ACK 24 that is an ACK to the wireless terminal station 4, after a predetermined transmission interval 21 elapses from a period of time 13. However, a method of transmitting the ACK is not limited to this, and a predetermined transmission interval 21 may be provided between each of the transmission of the ACK 22, the transmission of the ACK 23, and the transmission of the ACK 24. The predetermined transmission interval 21 is equivalent to a short inter frame space (SIFS) in IEEE 802.11.

In the wireless terminal station 3, the transmission request occurs between a period of time from the point in time 12 to the point in time 13 during which at least one of the wireless terminal stations 1, 2, and 4 transmits the transmission frame. The wireless terminal station 3 implements the transmission waiting until a point in time 14 at which the wireless terminal stations 1, 2, and 4 end up receiving the ACK. The wireless terminal station 3 starts the DCF control from the point in time 14 at which the channel is in the idle state. The wireless terminal station 3 starts to transmit a transmission frame 33 at a point in time 15 at which the DCF control time 25 has elapsed from the point in time 14. A point in time 16 is a point in time at which the wireless terminal station 3 stops the transmission.

The base station 5 receives a signal from the wireless terminal station 3 during a period of time 26, and transmits an ACK 28 that is an ACK to the wireless terminal station 3 after a transmission interval 27 elapses from the point in time 16. Like the predetermined transmission interval 21, the predetermined transmission interval 27 is also equivalent to the SIFS in IEEE 802.11.

Next, the timing chart that results from enlarging a period of time from the point in time 11 to the point in time 13, of the entire timing chart will be described. As described above, Each transmission request of the wireless terminal stations 2 and 4 occurs before the point in time 11 at which the channel is in the busy state. Each of the wireless terminal stations 2 and 4 starts the DCF control at the point in time 11 at which the channel is in the idle state.

As described above, according to the present embodiment, a sum of the DIES time and the back-off time is referred to as the DCF control time. A transmission interval 36 in FIG. 2 is equivalent to the DIFS in IEEE 802.11 specifications. Furthermore, blank times 38 to 43 in FIG. 2 are equivalent to slot time in IEEE 802.11 specifications.

With the DCF control, the wireless terminal station 2 obtains 2 as Random ( ) in (Equation 1). The wireless terminal station 2 does not perform the carrier sensing until the point in time 17 after the predetermined transmission interval 36 has elapsed from the point in time 11, and subsequently performs the carrier sensing during empty interval 39 and 40 that make up the back-off time. Because the channel is not busy at the point in time 12 after the DCF control time has elapsed from the point in time 11, the wireless terminal station 2 transmits the transmission frame 32 that is configured from a short training field (STF) 44 that is a symbol synchronization field, a long training field (LTF) 45 that is a channel estimation field, a signal field 46 that includes packet length information on transmission transmission data, and pieces of data from data 47 to data 48.

With the DCF control, the wireless terminal station 4 obtains 3 as Random ( ) in (Equation 1). Like the wireless terminal station 2, the wireless terminal station 4 starts the DCF control from the point in time 11. Because the channel becomes busy at the point in time 12 within the back-off time (empty periods of time 41 to 43), the wireless terminal station 4 stops the DCF control, and transmits the transmission frame 35 that is configured from an STF 56 that is a symbol synchronization field, an LTF 57 that is a channel synchronization field, a signal field 58 that includes the packet length information on the transmission data, and pieces of data from data 59 to data 60, after the delay point in time 34 elapses from the point in time 12.

In the wireless terminal station 1, the transmission request occurs during a period of time from the point in time 11 to the point in time 12 during which the channel is in the idle state. The wireless terminal station 1 starts the DCF control immediately after the transmission request occurs. With the DCF control, the wireless terminal station 1 obtains 1 as Random ( ) in Equation 1. Because the channel becomes busy at the point in time 12 within the back-off time (an empty period of time 38), like the wireless terminal station 4, the wireless terminal station 1 stops the DCF control, and transmits the transmission frame 30 that is made up of an STF 50 that is the symbol synchronization field, an LTF 51 that is the channel synchronization field, a signal field 52 that includes the packet length information on the transmission data, and pieces of data from data 53 to data 54, after the delay point in time 29 elapses from the point in time 12.

As understood from FIG. 2, according to the present embodiment, in order for the base station 5 to detect a symbol synchronization field from the transmission frame of each of the wireless terminal stations 1 to 4, each of the wireless terminal stations 1 to 4 sets the delay time in such a manner that an interval for the transmission starting timing of each of the wireless terminal stations 1 to 4 is a time that exceeds a symbol synchronization field length. Furthermore, in an MMSE adaptive array technology that uses an OFDM guard section, an effect that signals that are received at the same time are asynchronous to an interference signal in each of the guard sections is obtained. For this reason, in each of the wireless terminal stations 1 to 4, the interval for the transmission starting timing of each of the wireless terminal stations 1 to 4 is an interval that results from a symbol synchronization field length and a guard interval length that are described above. A method of setting the delay time will be described below.

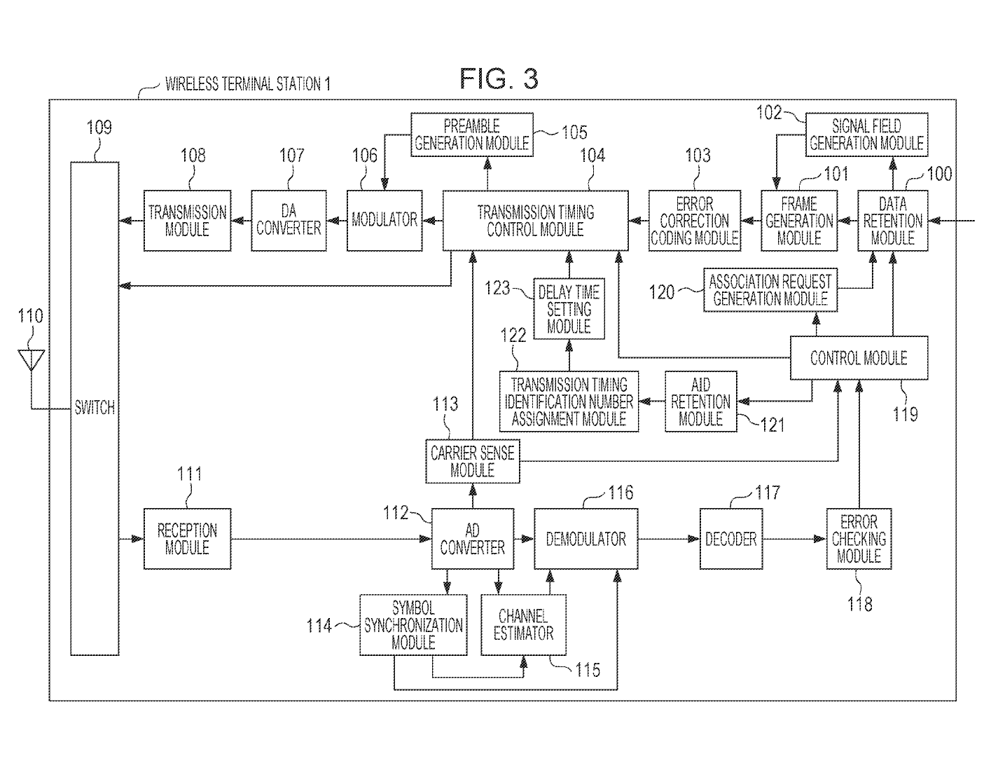

FIG. 3 is a functional block diagram illustrating one configuration example of the wireless terminal station 1 according to the present embodiment. Moreover, the function and configuration of each of the wireless terminal stations 2 to 4 are assumed to be the same as those of the wireless terminal station 1. The wireless terminal station 1 that is illustrated in FIG. 3 is configured from one antenna 110, a switch 109, a transmission module 108, a reception module 111, a DA converter 107, an AD converter 112, a modulation module 106, a preamble generation module 105, a transmission timing control module 104, an error correction coding module 103, a frame generation module 101, a signal field generation module 102, a data retention module 100, an association request generation module 120, a delay time setting module 123, a control module 119, a transmission timing identification number assignment module 122, an AID retention module 121, a demodulator 116, a decoder 117, an error checking module 118, a carrier sensing module 113, a symbol synchronization module 114, and a channel estimator 115. Processing in each functional block will be described below.

According to an instruction from the control module 119, the association request generation module 120 generates an association request. The data retention module 100 retains an information bit that is input. Furthermore, packet length information on the transmission frame is notified to the signal field generation module 102 from the retained information bit.

The signal field generation module 102 generates a signal field that includes the packet length information which is notified from the data retention module 100, and inputs the generated signal field to the frame generation module 101. The frame generation module 101 generates a transmission signal frame that results from adding the signal field that is input from the signal field generation module 102, to a MAC frame to which a frame check sequence (FCS) field and the like are added, from the transmission data that is input from the data retention module.

The error correction coding module 103 performs error correction coding of the transmission signal frame to which the signal field that is input from the frame generation module 101 is added. The transmission timing control module 104 controls transmission timing of the transmission signal frame that is input by the error correction coding module 103. However, a method of controlling transmission of the association request is assumed to be the same as the DCF control in the related art. A control method relating to data transmission will be described in detail below.

According to an instruction from the transmission timing control module 104, the preamble generation module 105 generates a preamble that is added to the transmission signal frame that is retained in the transmission timing control module 104. The symbol synchronization field and the channel estimation field are included in the preamble. The modulation module 106 performs OFDM modulation of a preamble field that is input from the preamble generation module 105, and performs the OFDM modulation of the transmission frame that is input by the transmission timing control module 104.

The DA converter 107 performs digital-to-analog (D/A) conversion of a digital signal that is input, into an analog signal. The transmission module 108 up-converts the baseband analog signal that is input, into a radio frequency band, and outputs a result of the up-convert to the switch 109. The switch 109 connects the transmission module 108 and the antenna 110 to each other at a timing that is notified from the transmission timing control module 104, and connects the reception module 111 and the antenna 110 at the other timings.

The reception module 111 down-converts the analog signal in the radio frequency band, which is input by the switch 109, into a baseband. The AD converter 112 performs the analog-to-digital (A/D) conversion of the analog signal that is input by the reception module 111, into the digital signal. The carrier sensing module 113 checks on a channel-used state using the digital signal that is input from the AD converter 112.

The symbol synchronization module 114 detects the symbol synchronization field from the signal that is input from the AD converter 112, and achieves symbol synchronization. The channel estimator 115 extracts from a channel estimation field the signal that is input from the AD converter 112, at a timing that is notified from the symbol synchronization module 114, and performs channel estimation.

The demodulator 116 demodulates the signal that is input from the AD converter 112 into reception data using channel information that is obtained by the channel estimator 115 and a symbol synchronization timing that is obtained by the symbol synchronization module 114. The decoder 117 decodes the post-demodulation signal that is input from the demodulator 116 and generates a decoded information bit.

The error checking module 118 refers to an FCS field and a frame control field from the decoded information bit that is input by the decoder 117, and performs checking of an error within the MAC frame. The control module 119 determines the type of receive frame, from the reception data that is input by the error checking module 118. In accordance with the type of receive frame, the control module 119 controls an operation in each functional block. Furthermore, the control module 119 instructs the association request generation module 120 and the transmission timing control module 104 to transmit the association request.

The AID retention module 121 acquires the AID from an association response that is input by the control module 119. The transmission timing identification number assignment module 122 assigns the transmission timing identification number using the AID that is input by the AID retention module 121. A method of assigning the transmission timing identification number will be described below.

With the transmission timing identification number that is input by the transmission timing identification number assignment module 122, the delay time setting module 123 sets the delay time. The method of setting the delay time will be described below. The wireless terminal station 1 that is illustrated in FIG. 3 performs data exchange or error detection in units of frames.

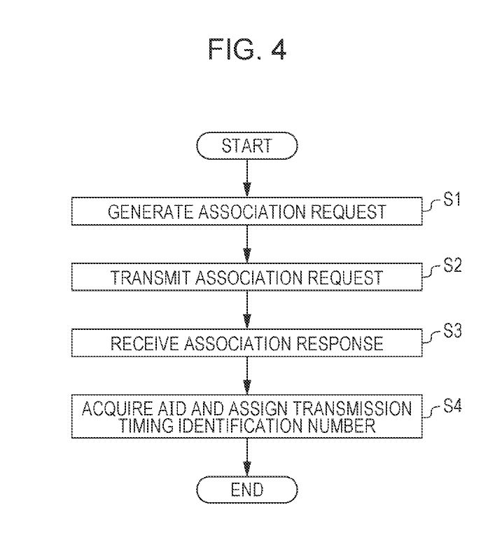

FIG. 4 is a flowchart illustrating an operation in which the wireless terminal station 1 performs association establishment. The association establishment by the wireless terminal station 1 will be described below referring to FIG. 4. According to an instruction of the control module 119, the wireless terminal station 1 generates the association request in the association request generation module 120 (Step S1) and transmits the association request using the antenna 110 (Step S2). If the association request is transmitted, the wireless terminal station 1 receives the association response from the base station 5 (Step S3). The wireless terminal station 1 acquires the AID that is included in the association response and assigns the transmission timing identification number (Step S4). One example of a formula for calculating the transmission timing identification number is expressed as Equation 2.

[Math. 2]

Transmission timing identification number=AID % N Equation 2

where an operator “%” means a remainder. To be more precise, “A % B” indicates a “remainder that results from dividing A by B. At this time, the transmission timing identification number can take an integer ranging from 0 to N−1. To be more precise, N indicates the number of integers that the transmission timing identification number can take. For example, in a case where as is the case with the wireless terminal stations 1 to 4 in FIG. 2, the transmission timing identification number ranges from 0 to 3, an integer N is assumed to be 4. With the method described above, the transmission timing identification number can be calculated. However, the method of calculating the transmission timing identification number is not limited to the method described above.

Furthermore, a method of calculating the delay time that is obtained from the transmission timing identification number will be described below. In a case of IEEE 802.11a, when the STF that is the symbol synchronization field for the wireless terminal station 1 overlaps the transmission frame of at least one wireless terminal station among the other wireless terminal stations 2 to 4 in terms of the time axis, the base station 5 cannot detect the STF for the wireless terminal station 1. Furthermore, with the MMSE adaptive array technology that uses the guard section of the signal which uses the cyclic prefix, an effect that a difference in an arrival point in time between a desired signal and the interference signal is a predetermined ratio with respect to the guard interval length or above is obtained. However, the predetermined ratio is not particularly limited, and is a value that differs with a system or channel state.

According to the present embodiment, for the reason described above, the delay time is set that differs by an interval that exceeds the sum of times of predetermined ratios with respect to at least the symbol synchronization field length and the guard interval length for every transmission timing identification number. One example of a method of calculating a delay time T (a transmission timing identification number) with respect to each transmission timing identification number is expressed as Equation 3.

[Math. 3]

$$τ ( Transmission timing identification number ) = ( L + \frac{1}{N + 1} ) \times ( Transmission timing identification number + 1 ) \times OFDM symbol length \qquad Equation 3$$

where L indicates a length ratio of the symbol synchronization field length to the OFDM symbol length. For example, in the case of IEEE 802.11a, because the STF for the symbol synchronization field is two times the OFDM symbol length, L=2. Furthermore, the OFDM symbol length at this point is a time that results from adding the guard interval to the valid OFDM symbol length. With the method described above, the delay time can be set at an interval in which the delay time of the wireless terminal station that has a different transmission timing identification number exceeds the symbol synchronization field length.

For example, in IEEE 802.11a, when N=4, the delay time, as expressed in Equation 4, is set for the wireless terminal station that has a transmission timing identification number that is 0.

[Math. 4]

$$τ ( 0 ) = ( 2 + \frac{1}{5} ) \times OFDM symbol length \qquad Equation 4$$

In the same manner, τ(1)=(4+2/5)*OFDM symbol length is set, as the delay time, for the wireless terminal station having the transmission timing identification number that is 1, τ(2)=(6+3/5)*OFDM symbol length is set, as the delay time, for the wireless terminal station having the transmission timing identification number that is 2, and τ(3)=(8+4/5)*OFDM symbol length is set, as the delay time, for the wireless terminal station having a transmission timing identification number that is 3. However, the method of setting the delay time is not limited to this method, and the delay time that is assigned to every transmission timing identification number may be a time that is based on an STF time that is at least the symbol synchronization field length and on a time of a predetermined ratio with respect to the guard interval length. In the method in Equation 4, a predetermined ratio with respect to the guard interval length is ⅕. Furthermore, in the method in Equation 4, the delay time is set that differs by a constant for every transmission timing identification number, but the delay time is not limited to one that differs by a constant. For example, the delay time may be set, for example, such as τ(0)=11/5×OFDM symbol length, τ(1)=23/5×OFDM symbol length, and τ(2)=34/5×OFDM symbol length.

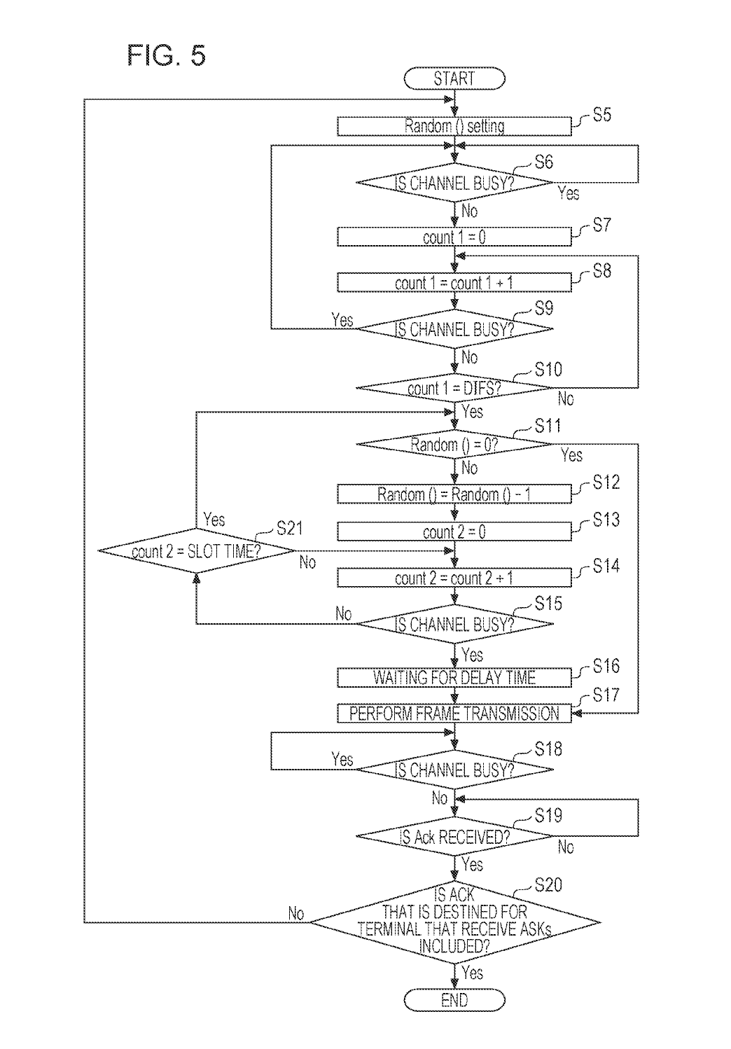

FIG. 5 is a flowchart for a period of time from when the transmission request occurs to when the wireless terminal station 1 receives the ACK. If the transmission request occurs, Random ( ) in Equation 1 is set (Step S5). After Step S5, waiting is implemented until the channel is in the idle state (Step S6). If the channel is in the idle state, count 1 is set to 0 (step S7). Next, the count 1 counts up and waiting is implemented for one unit time (Step S8). One unit time here is an interval at which the carrier sensing is performed, and is assumed to be, for example, 1 μs. Each time the count 1 counts up, it is checked whether or not the channel is busy (Step S9), and if the channel is not busy, it is checked whether or not the count 1 becomes the DIFS time (Step S10). In a case where the channel is busy in Step S9, it is assumed that there is a high likelihood that a signal having a high priority ACK and the like will be transmitted, and the process proceeds to Step S6.

In Step S10, in a case where the count 1 is not the DIFS time, the count 1 continues to count up (Step S8). Furthermore, in a case where the count 1 is the DIFS time, random back-off starts. Furthermore, it is checked whether or not Random is 0 (Step S11). In a case where Random ( )=0, the transmission frame to which the preamble is added is immediately transmitted (Step S17).

In a case where Random ( ) is not 0 in Step S11, Random ( ) counts down (Step S12). Next, count 2 is set to 0 (Step S13). After Step S13, the count 2 counts up, and waiting is implemented for one unit time (Step S14). One unit time here is an interval at which the carrier sensing is performed as described above. Each time the count 2 counts up, it is checked whether or not the channel is busy (Step S15). In a case where the channel is busy in Step S15, waiting is implemented for the delay time that is set by the transmission timing identification number (Step S16). In a case where the channel is idle in Step S14, it is checked whether or not the count 2 is a slot time (Step S21). In a case where the count 2 is the slot time, it is again checked whether or not Random ( ) is 0 (Step S11). In a case where the count 2 is not the slot time in Step S21, the counting-up of the count 2 is again performed (Step S14).

After Step S16, the wireless terminal station 1 starts to transmit the transmission frame to which the preamble is added (Step S17). Next, waiting is implemented until the channel is always in the idle state (Step S18). If the channel becomes in the idle state, waiting is implemented until the ACKs are received the SIFS time later (Step S19). If the ACKs are received, it is checked whether or not the ACK that is destined for the terminal that receives the ACKs is included in the received ACKs (Step S20). If the ACK that is destined for the terminal that receives the ACKs is included, communication processing is ended, and waiting is implemented until a next transmission data is retained in the data retention module 100. In a case where in Step S20, the ACK that is destined for the terminal that receives the ACKs is not included, Step S5 is started using the data that is retained in the data retention module 100.

With the method described above, the wireless terminal station 1 transmits the data. The wireless terminal stations 2 to 4 can also realize the system that is illustrated in FIG. 2, by performing transmission of a data frame with the same processing.

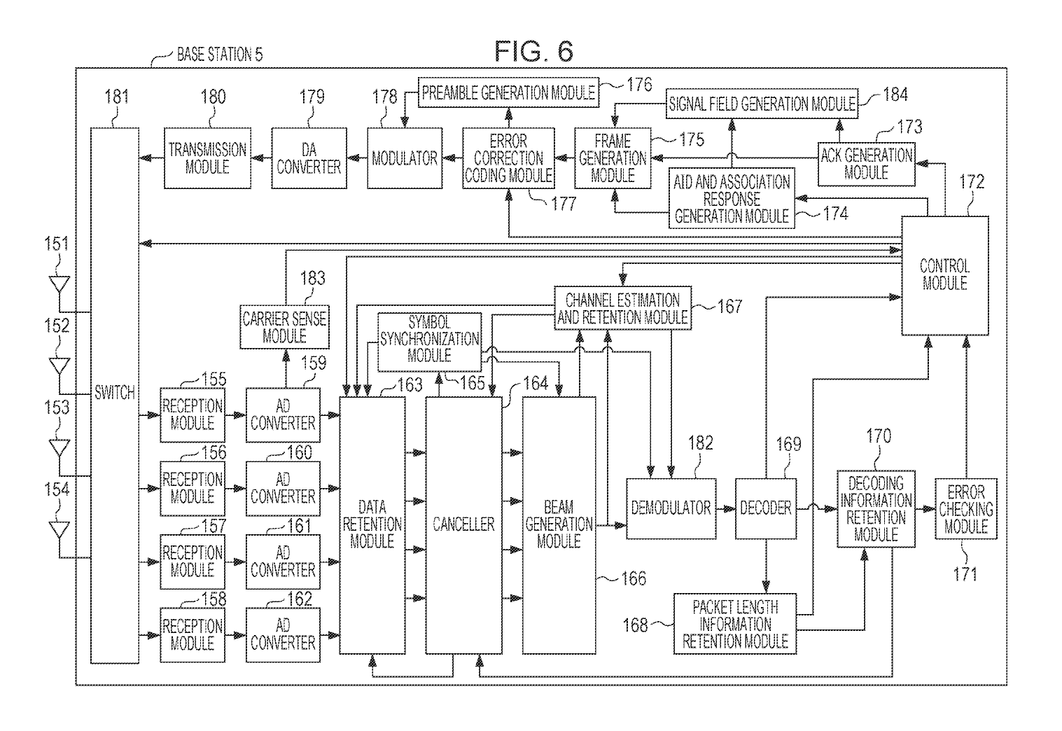

FIG. 6 is a functional block diagram illustrating one configuration example of the base station 5 according to the present embodiment. As illustrated in FIG. 6, the base station 5 is configured from four antennas 151 to 154, four reception modules 155 to 158, four AD converters 159 to 162, a data retention module 163, a canceller 164, a symbol synchronization module 165, a beam generation module 166, a channel estimation and retention module 167, a demodulator 182, a packet length information retention module 168, a decoder 169, a decoding information retention module 170, an error checking module 171, a control module 172, an ACK generation module 173, an AID and association response generation module 174, a signal field generation module 184, a frame generation module 175, an error correction coding module 177, a preamble generation module 176, a modulation module 178, a DA converter 179, a transmission module 180, and a switch 181. Each functional block will be described below.

The antennas 151 to 154 receive a signal. According to an instruction of the control module 172, the switch 181 connects the antennas 151 to 154 and the reception modules 155 to 158 to each other, or connects at least one among the antennas 151 to 154 and the transmission module 180 to each other. The reception modules 155 to 158 down-convert analog signals in radio frequency bands, which are input from the antennas 151 to 154, into a baseband, respectively.

The AD converters 159 to 162 A/D-convert the analog signals that are input from the reception modules 155 to 158, into digital signals, respectively. A carrier sensing module 183 checks on a channel-used state using the digital signal that is input by an AD converter 159. However, according to the present embodiment, the carrier sensing is performed using the digital signal that is input by the AD converter 159, but any digital signal that is input from at least one among the four AD converters 159 to 162 may be used.

The data retention module 163 retains the digital signals that are input from the AD converters 159 to 162. The data retention module 163 can store data of the signals that are received from all the antennas as much as at least a sum of a maximum delay time and a maximum packet length. Furthermore, the data that is retained in the data retention module 163 is always updated with the data that is input from the canceller 164. Furthermore, the data retention module 163 receives instructions from the control module 172, the symbol synchronization module 165, and the channel estimation and retention module 167, and thus inputs the data, which is retained, into the canceller 164.

The canceller 164 subtracts, from the signal that is input from the data retention module 163, a signal that results from multiplying a signal that results from re-modulating and re-decoding the information bit that is demodulated and decoded in the previous processing, and the channel information. However, it is assumed that in the first processing, neither the information bit that is demodulated and decoded in the previous processing nor the channel information is present, and that the canceller 164 does not perform any processing.

The symbol synchronization module 165 performs detection of the symbol synchronization field from the signal that is input by the canceller 164. The beam generation module 166 generates a beam of an MMSE adaptive array antenna that uses the guard section, from the signal that is input from the canceller. The channel estimation and retention module 167 performs estimation of the channel that is present before the beam is generated, using the channel estimation field that results after the beam that is input by the beam generation module 166 is generated, and weight, and retains a result of performing the estimation. After the channel information is estimated with the channel estimation field, the channel information that results after the beam which is used for demodulation of an OFDM symbol that follows the channel estimation field is generated is estimated.

The demodulator 182 demodulates the channel information that results after the beam that is input from the channel estimation and retention module 167 is generated, and the OFDM symbol that is input from the beam generation module 166. With demodulation decoding information in the signal field that is input from the decoder 169, the packet length information retention module 168 acquires and retains the packet length information.

The decoder 169 decodes demodulation information that is input from the demodulator 182. The decoding information retention module 170 continues to retain decoding information that is input from the decoder 169, to the extent of a packet length that is notified by the packet length information retention module 168. If the pieces of decoding information are accumulated in the decoding information retention module 170 to the extent of the packet length, the decoding information retention module 170 inputs the pieces of decoding information that are accumulated, into the error checking module 171.

The control module 172 performs control of multiple functional blocks. In decoding demodulation processing, in a case where a notification is received from the decoder 169 in every decoding processing, and the packet length that is notified by the packet length information retention module 168 is not reached, an instruction is given in such a manner that a next field is output from the data retention module 163 to the canceller. Furthermore, a type of reception signal is determined from the information bit that is input from the error checking module 171.

The ACK generation module 173 receives an instruction from the control module 172 and thus generates ACK information of the reception data. In the same manner, the AID and association response generation module 174 also receives the instruction from the control module 172 and sets the AID, and thus generates the association response that includes AID information. The signal field generation module 184 acquires the packet length information from the ACK generation module 173 or the AID and association response generation module 174, and generates the signal field that includes the packet length information.

The frame generation module 175 generates a transmission MAC frame from pieces of information that are input from the ACK generation module 173 or the AID and association response generation module 174, and generates the transmission signal frame to which the signal field that is input from the signal field 184 is added.

The error correction coding module 177 performs the error correction coding of the transmission signal frame that is input from the frame generation 175. The preamble generation module 176 receives an instruction from the error correction coding module 177, and thus generates the preamble that is added to the transmission signal frame that is input to the error correction coding module 177. The modulation module 178 modulates the information bit that is input, and the DA converter 179 D/A conversion of the digital signal that is input from the modulation module 178, into the analog signal.

The transmission module 180 up-converts the analog signal that is input from the DA converter 179, into the transmission frequency. The switch 181 receives an instruction from the control module 172, and thus switches a connection. Like the wireless terminal station 1, the base station 5 is assumed to perform the data exchange or to perform the error detection in units of frames.

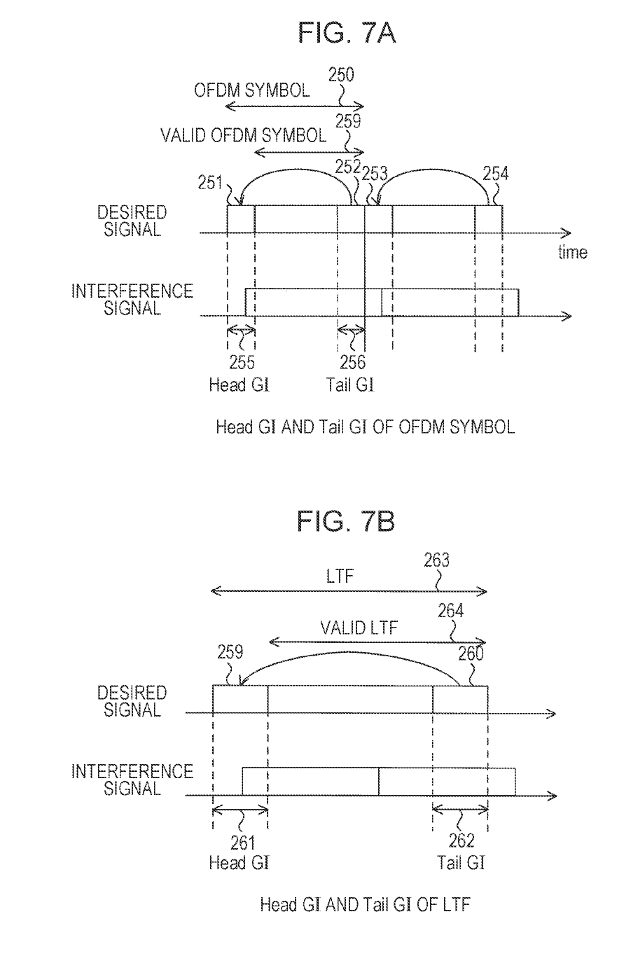

A function of the beam generation module 166 in FIG. 6 will be described in detail below. FIGS. 7A and 7B are examples of timing charts of a reception signal of a base station 1. FIG. 7A is a timing chart of the OFDM symbol. As understood from a desired signal, generally, in order for the OFDM symbol to have difficulty in receiving an influence of a multi-path, a copy of a guard section sample 252 that is the tail of a valid OFDM symbol 259 is added to the head of the valid OFDM symbol, and generates an OFDM symbol section 250. To be more precise, a sample 251 and a sample 252 are the same. In the same manner, a sample 253 that results from copying a guard section sample 254 in the back is added to the head of the valid OFDM symbol. This desired signal is one that results from calculating weight that depends on a MMSE, using the fact that a head GI section 255 that is the head section of the continuous OFDM symbols and a tail GI section 256 that is the tail section of the continuous OFDM symbols are equal to each other.

Furthermore, FIG. 7B is a timing chart that results when the LTF that is a channel estimation field in IEEE 802.11 is received. As understood from FIG. 7B, a length of an LTF section 263 in IEEE 802.11 is two times a length of the OFDM section 250, and in the LTF section 263, a signal is received in which a sample 259 that is a copy of a sample 260 which is the tail of a valid LTF symbol section 264 is added to a sample in a valid LTF section. To be more precise, when the LTF is modulated, a section 261 as the head GI section and a section 262 as the tail GI section are used.

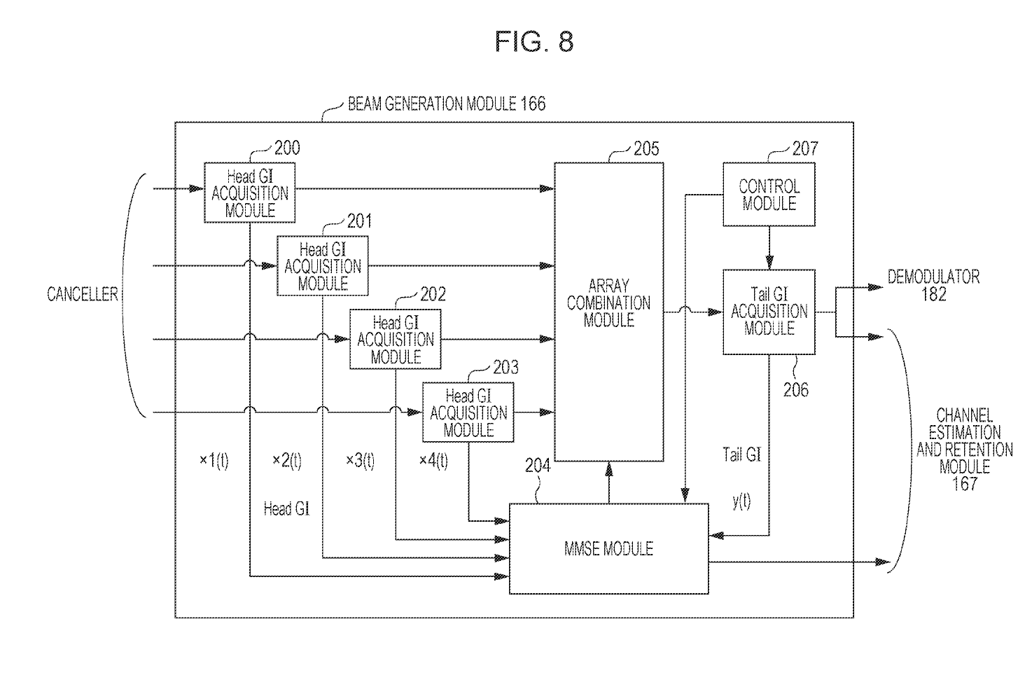

FIG. 8 is one example of a functional block diagram of the beam generation module 166 in FIG. 6. As illustrated in FIG. 8, the beam generation module 166 is configured from four head GI acquisition modules 200 to 203, an array combination module 205, a tail GI acquisition module 206, and an MMSE module 204.

The head GI acquisition modules 200 to 203 acquire the head GI section 255 that is illustrated in FIG. 7, or a head GI section 261, from a sample that is input, and input the acquired head GI section 255 or head GI section 261 into the MMSE module 204. The array combination module 205 performs weighting combination, which depends on weight that is input from the MMSE module 204, on the reception signal that is input through the head GI acquisition modules 200 to 203.

The tail GI acquisition module 206 acquires the tail GI section 256 in FIG. 7 or a tail GI section 262, the number of repetitions that is prescribed by the control module 207, from symbols that go through array combination, which are input from the array combination module 205, and inputs the acquired tail GI section 256 or tail GI section 262 into the MMSE module 204. If the processing is performed the number of repetitions that is prescribed by the control module 207, in a case of the channel estimation field, the tail GI acquisition module 206 inputs an output from the array combination module 205 into the channel estimation and retention module 167. In a case of the other fields, the tail GI acquisition module 206 inputs the output from the array combination module 205 into the demodulator 182.

The MMSE module 204 operates an adaptive array in compliance with an MMSE standard the number of repetitions that is prescribed by the control module 207, using a sample in a head GI section of a signal that is acquired from the head GI acquisition modules 200 to 203 and that is received in the antennas 151 to 154, and a sample of a tail GI section of a signal that goes through the array combination and that is acquired from the tail GI acquisition module 206, and calculates the weight. The MMSE module 204 inputs the calculated weight into the array combination module 205 until the processing is performed the number of repetitions that is prescribed by the control module 207. If the processing is performed the number of repetitions that is prescribed by the control module 207, the MMSE module 204 outputs the weight to the array combination module 205 and the channel estimation and retention module 167.

A method of calculating the weight, which is performed by the MMSE module 204, will be described below. At a point in time t, a baseband signal that is input into the MMSE module 204 is defined as X(t)=[x1(t), x2(t), x3(t), x4(t)]^{T}. However, x1(t) is a signal that results from inputting a signal that is received in the antenna 151 into the beam generation module 166 through the reception module 155, the AD converter 159, the data retention module 163, and the canceller 164. In the same manner, x2(t) is a signal that results from inputting a signal that is received in the antenna 152 into the beam generation module 166 through the reception module 156, the AD converter 160, the data retention module 163, and the canceller 164, x3(t) is a signal that results from inputting a signal that is received in the antenna 153 into the beam generation module 166 through the reception module 157, the AD converter 161, the data retention module 163, and the canceller 164, and x4(t) is a signal that results from inputting a signal that is received in the antenna 154 into the beam generation module 166 through the reception module 158, the AD converter 162, the data retention module 163, and the canceller 164. []^{T} indicates transposition. Furthermore, weight that is a 4 (the number of receive antennas that the base station 5 has)×1 matrix that is input from the MMSE module 204 into the array combination module 205 is defined as W, and a signal that is input from the tail GI acquisition module 206 into the MMSE module is defined as y(t). At this time, in the MMSE module 204, an evaluation function that is expressed in Equation 5 is minimized.

[Math. 5]

E[|e(t)|²]=E[|y(t)−W^{H}X(t)|²] Equation 5

where E[] means an expected value operation, and []^{H} means Hermitian transposition. With the method described above, the MMSE module 204 calculates the weight.

The control module 207 performs control in such a manner that the tail GI acquisition module 206 and the MMSE module 204 perform the processing the predetermined number of repetitions. The predetermined number of repetitions is not particularly limited.

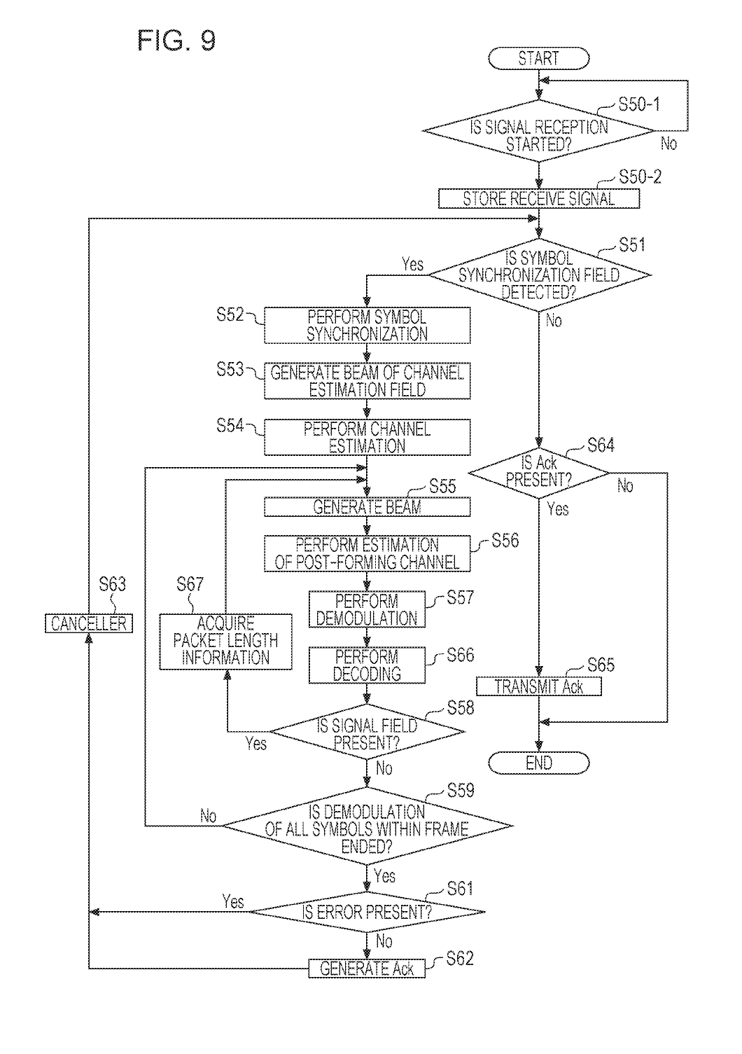

FIG. 9 is a flowchart for a period of time from when the base station 5 receives the signal to when the base station 5 transmits the ACK. The base station 5 waits until the signal is received in the antennas 151 to 154 (Step S50-1). When the signal is received in the antennas 151 to 154 (Step S50-2), the signal passes through the reception modules 155 to 158, the AD converters 159 to 162, the data retention module 163, and the canceller 164, and the symbol synchronization field is detected in the symbol synchronization module 165 (Step S51). In a case where the symbol synchronization field is detected in Step S51, the symbol synchronization module 165 gains the symbol synchronization (Step S52), and notifies the data retention module 163, the beam generation module 166, and the demodulator 182 of timing of the symbol synchronization.

Subsequent to the symbol synchronization (Step S52), the channel estimation field passes through the data retention module 163 and the canceller 164, and a beam of the channel estimation field is generated in the beam generation module 166 (Step S53). In a method of generating the beam of the channel estimation field, as illustrated in FIG. 7B, it is noted that other OFDM symbols differ in the head GI section and the tail GI section. If generation of the beam of the channel estimation field (Step S53) is ended, the channel information is estimated in the channel estimation and retention module 167 (Step S54). However, the channel information that is estimated in the channel estimation and retention module 167 is channel information of a desired signal that is present before the weight is applied.

If the channel estimation (Step S54) is ended, a beam is generated in the beam generation module 166 using a signal subsequent to the channel estimation field (Step S55). As described above, if the processing is performed the predetermined number of repetitions, the beam generation module 166 notifies the channel estimation and retention module 167 of the weight.

The channel estimation and retention module 167 estimates the channel information that is used in the demodulator 182, from the weight that is input from the beam generation module and from the channel information that is retained (Step S56). The channel information that goes through beam formation and that is estimated in the channel estimation and retention module 167 is input into the demodulator 182. The demodulator 182 demodulates the OFDM symbol that is input from the beam generation module 166, based on the channel information that is input from the channel estimation and retention module 167 (Step S57).

Next, the decoder 169 performs the decoding of the OFDM symbol that is input from the demodulator 182, and the decoded OFDM symbol is stored in the decoding information retention module 170 (Step S66). The decoder 169 determines from a type of the immediately-preceding field whether or not the decoded signal is a signal field (Step S58), and in a case where the type is the signal field, acquires the packet length information from the decoding information (Step S67) and inputs the acquired packet length information into the packet length information retention module 168. If the packet length information is acquired, demodulation processing of data subsequent to the signal field is started (Step S55).

The packet length information retention module 168 notifies the decoding information retention module 170 and the control module 172 of the packet length that is notified from the decoder 169. In a case where it is determined in Step S58 that a decoded signal is not the signal field, the control module 172 and the decoding information retention module 170 checks, from the packet length notified from the packet length information retention module 168, whether or not the demodulation and the decoding of all OFDM symbols that are included in the packet are ended (Step S59).

In a case where all the OFDM symbols are not demodulated and decoded in Step S59, the control module 172 starts the demodulation processing of a next OFDM symbol (Step S55). In Step S59, if the demodulation and the decoding of the all OFDM symbols within the packet are confirmed, the decoding information retention module 170 inputs the pieces of decoding information into the error checking module 171 in a manner that corresponds to one packet. The error checking module 171 performs the error checking from the decoding information that is input (Step S61).

If an error is not confirmed in Step S61, the ACK generation module 173 generates an ACK according to an instruction from the control module 172 (Step S62). If the error is confirmed in Step S61, the control module 172 instructs the data retention module 163 to input the retained data into the canceller 164 (Step S63).

If the ACK is generated (Step S62), the data retention module 163 receives an instruction from the control module 172, and thus again inputs the retained data into the canceller 164. The canceller 164 subtracts, from a signal that is input from the data retention module 163, a signal that results from multiplying the channel information that is retained in the channel estimation and retention module 167 and a signal that results from re-coding and re-modulating the information bit that is input from the decoding information retention module 170. With the method described above, the canceller 164 performs canceling (Step S63). Furthermore, a signal that is canceled in the canceller 164 is overwritten as data of the data retention module 163.

Subsequent to Step S63, the processing proceeds to Step S51. If in Step S51, the symbol synchronization field cannot be detected from all pieces of data that are retained in the data retention module 163, it is checked whether or not an ACK is generated in the ACK generation module 173 (Step S64). In a case where the ACK is generated, the ACK is transmitted (Step S65).

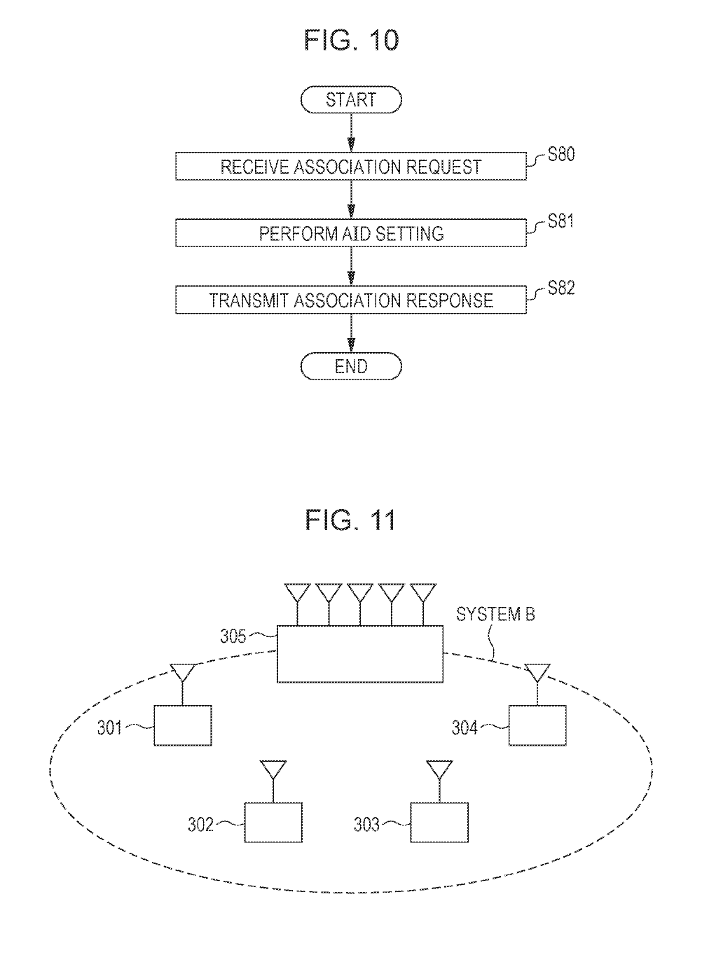

FIG. 10 is a flowchart for a period of time from when the base station 5 receives the association request to when the base station 5 transmits the association. The base station 5 receives the association request (Step S80). If the association request is received, the AID is set in the AID and association response generation module 174 (in Step S81), and the association response is transmitted (Step S82). In the processing described, processing that transmits the association response is ended.

Communication as in the timing chart in FIG. 2 can be realized by using the wireless terminal station 1 that is illustrated in FIG. 3, the wireless terminal stations 2 to 4 that have the same function as the wireless terminal station 1, and the base station 5 that is illustrated in FIG. 6. However, according to the present embodiment, in a case where the other wireless terminal stations 2 to 4 start transmission during the DCF control time, the wireless terminal station 1 stops the DCF control, and starts transmission after a predetermined delay time elapses, but communication may be started without the DCF control after a predetermined delay time has elapsed from when the channel is idle.

Accordingly, uplink communication can be efficiently performed with an MMSE adaptive array that uses the guard section of the signal which uses the cyclic prefix.

### Second Embodiment

According to the present embodiment, portions that are not described are also assumed to be fundamentally based on IEEE 802.11 specifications and IEEE 802.11a specifications. FIG. 11 is one example of a schematic diagram according to the present embodiment. According to the present embodiment, a case is described where an OFDM signal to which a guard interval is added is used as a signal that uses a cyclic prefix. However, the signal that uses the cyclic prefix is not limited to the OFDM signal to which the guard interval is added.

As illustrated in FIG. 11, a wireless communication system B according to the present embodiment has a base station 305 that includes five antennas, and four wireless terminal stations 301 to 304, each of which has one antenna. The base station 305 and the four wireless terminal stations 301 to 304 assume that a wireless signal reaches all communication stations which are included in the system. In the wireless communication system B that is illustrated in FIG. 11, transmission frequencies of the wireless terminal stations 301 to 304 are all the same. Furthermore, according to the present embodiment, the transmission frequency of each of the wireless terminal stations 301 to 304 is different from the transmission frequency of the base station 305. To be more precise, the base station 305 and each of the wireless terminal stations 301 to 304 are different in the transmission frequency and the reception frequency. Moreover, according to the present embodiment, for brief description, the number of antennas that are to be included in each of the four wireless terminal stations 301 to 304 is assumed to be 1, but multiple antennas may be provided. In the same manner, the number of antennas that are to be included in the base station 305 may be changed.

According to the present embodiment, one example of a method in which the wireless terminal stations 301 to 304 start to perform transmission based on a current point-in-time timer that is included in each terminal and on an identification number that is assigned to each of the wireless terminal stations is described. The identification number that is assigned to each of the wireless terminal stations here indicates information that identifies the wireless terminal station, such as an AID, a MAC address, or a group ID. According to the present embodiment, a case where the group ID is used as the identification number that is assigned to each of the wireless terminal stations is described.

The group ID is identification information that is used in compliance with IEEE 802.11ac and the like, and is information that is notified to each of the wireless terminal stations, with which the base station establishes association. The group ID is configured from status information (membership status of) on a group to which the wireless terminal station that is notified belongs, and information on a position (STA position) within the group.

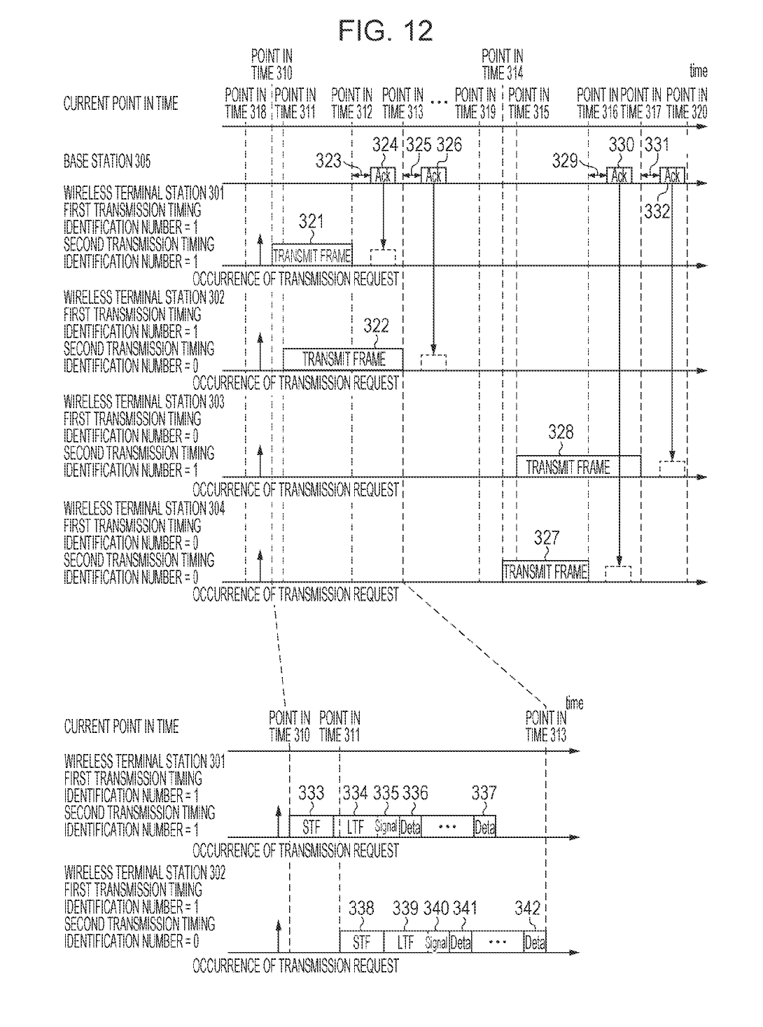

FIG. 12 is a diagram illustrating one example of a timing chart for a period of time from when with the transmission timing control, the wireless terminal stations 301 to 304 in FIG. 11 transmit the transmission frame to the base station 305 and to when the base station 305 transmits an ACK to each of the wireless terminal stations 1 to 4. Furthermore, FIG. 12 is configured from an entire timing chart and a timing chart that results from enlarging a period of time from a point in time 310 to a point in time 313 that is a portion of the entire timing chart. According to the present embodiment, before the transmission timing of the transmission frame, a first transmission timing identification number and a second transmission timing identification number are assigned, from the group ID, to each of the wireless terminal stations 301 to 304, and a transmission starting timing candidate that varies from one transmission timing identification number to another is assigned to each of the wireless terminal stations 301 to 304. In an example in FIG. 12, the wireless terminal station 301 is assigned 1 as the first transmission timing identification number, and 1 as the second transmission timing identification number. In the same manner, the wireless terminal station 302 is assigned 1 as the first transmission timing identification number and 0 as the second transmission timing identification number. The wireless terminal station 303 is assigned 0 as the first transmission timing identification number and 1 as the second transmission timing identification number. The wireless terminal station 304 is assigned 0 as the first transmission timing identification number and 0 as the second transmission timing identification number. A method of assigning the first transmission timing identification number and the second transmission timing identification number will be described below. Furthermore, a method of determining the transmission starting timing candidate will be also described below.

First, the entire timing chart is described. In one example in FIG. 12, the wireless terminal stations 301 and 302 are assigned 1 as the first transmission timing identification number. According to the present embodiment, a wireless terminal station that is assigned 1 as the first transmission timing identification number is controlled in such a manner that the transmission is started during a period of time from a point in time 310 to the point in time 319. Furthermore, also during such a period of time, the wireless terminal station 301 is assigned 1 as the second transmission timing identification number, and for the wireless terminal station 301, the point in time 310 is determined as the transmission starting timing candidate. In the same manner, the wireless terminal station 302 is assigned 0 as the second transmission timing identification number, and the wireless terminal station 302 is assigned the point in time 311 as the transmission starting timing candidate.

In the same manner as with each of the wireless terminal stations 301 and 302, the transmission starting timing candidate of the wireless terminal station that is assigned 0 as the first transmission timing identification number is determined. In one example in FIG. 12, each of the wireless terminal stations 303 and 304 is assigned 0 as the first transmission timing identification number. According to the present embodiment, a wireless terminal station that is assigned 0 as the first transmission timing identification number is controlled in such a manner that the transmission is started during a period of time from a point in time 314 to a point in time 320. Furthermore, also during such a period of time, the wireless terminal station 303 is assigned 1 as the second transmission timing identification number, and for the wireless terminal station 303, the point in time 315 is determined as the transmission starting timing candidate. In the same manner, the wireless terminal station 304 is assigned 0 as the second transmission timing identification number, and the wireless terminal station 304 is assigned the point in time 314 as the transmission starting timing candidate.

In the one example in FIG. 12, in the wireless terminal station 301, the transmission request occurs earlier than the point in time 310 that is the transmission starting timing that is assigned to the wireless terminal station 301, and transmission of a transmission frame 321 is started at the point in time 310. In the same manner, in the wireless terminal station 302, the transmission request occurs earlier than the point in time 311 that is the transmission starting timing that is assigned to the wireless terminal station 302, and transmission of a transmission frame 322 is started at the point in time 311.

In the base station 305, reception of the transmission frame 321 from the wireless terminal station 301 is ended at a point in time 312. In the base station 305, an ACK 324 that is an ACK to the wireless terminal station 301 is transmitted after a predetermined transmission interval 323 elapses from the point in time 312. However, the transmission frequency of the base station 305 at this time is different from the transmission frequency of each of the wireless terminal stations 301 to 304. Furthermore, the predetermined transmission interval 323 is equivalent to the SIFS in IEEE 802.11.

In the same manner, in the base station 305, reception of the transmission frame 322 from the wireless terminal station 302 is ended at a point in time 313. In the base station 305, an ACK 326 that is an ACK to the wireless terminal station 302 is transmitted after a predetermined transmission interval 325 elapses from the point in time 313. Furthermore, the predetermined transmission interval 325 is also equivalent to the SIFS in IEEE 802.11.

For the wireless terminal stations 303 and 304, transmission frames 327 and 328 are transmitted in the same method. In the one example in FIG. 12, in the wireless terminal station 304, the transmission request occurs earlier than the point in time 314 that is the transmission starting timing that is assigned to the wireless terminal station 304, and transmission of a transmission frame 327 is started at the point in time 314. In the same manner, in the wireless terminal station 303, the transmission request occurs earlier than a point in time 315 that is the transmission starting timing that is assigned, and transmission of a transmission frame 328 is started at the point in time 315.

In the base station 305, reception of a transmission frame 327 from the wireless terminal station 304 is ended at a point in time 316. In the base station 305, an ACK 330 that is an ACK to the wireless terminal station 304 is transmitted after a predetermined transmission interval 329 elapses from the point in time 316. However, the transmission frequency of the base station 305 at this time is different from the transmission frequency of each of the wireless terminal stations 301 to 304. Furthermore, the predetermined transmission interval 329 is equivalent to the SIFS in IEEE 802.11.

In the same manner, in the base station 305, reception of the transmission frame 328 from the wireless terminal station 303 is ended at a point in time 317. In the base station 305, an ACK 332 that is an ACK to the wireless terminal station 302 is transmitted after a predetermined transmission interval 331 elapses from the point in time 317. The transmit frequency here is assumed to be the same as the frequency that is used for transmission of an ACK 330. Furthermore, the predetermined transmission interval 331 is also equivalent to the SIFS in IEEE 802.11.

Next, the timing chart that is a diagram that results from enlarging a period of time from the point in time 310 to the point in time 313 that is a portion of the entire timing chart is described. In the wireless terminal station 301, the transmission request occurs earlier than the point in time 310 that is the transmission starting timing candidate, and the wireless terminal station 301 transmits the transmission frame 321 that is configured from a STF 333 that is a channel estimation field at the point in time 310, an LTF 334 that is a timing synchronization field, a signal field 335 that includes the packet length information on the transmission data, and pieces of data from data 336 to data 337.

In the same manner, in the wireless terminal station 302, the transmission request occurs earlier than the point in time 311 that is the transmission starting timing candidate, and the wireless terminal station 302 transmits the transmission frame 322 that is configured from a STF 338 that is a channel estimation field at the point in time 311, an LTF 339 that is a timing synchronization field, a signal field 340 that includes the packet length information on the transmission data, and pieces of data from data 341 to data 342.

As illustrated in FIG. 12, a difference between the point in time 310 that is the transmission starting timing candidate of the wireless terminal station 301 and the point in time 311 that is the transmission starting timing candidate of the wireless terminal station 302 exceeds a timing synchronization field length. A method of determining the transmission starting timing candidate will be described below.

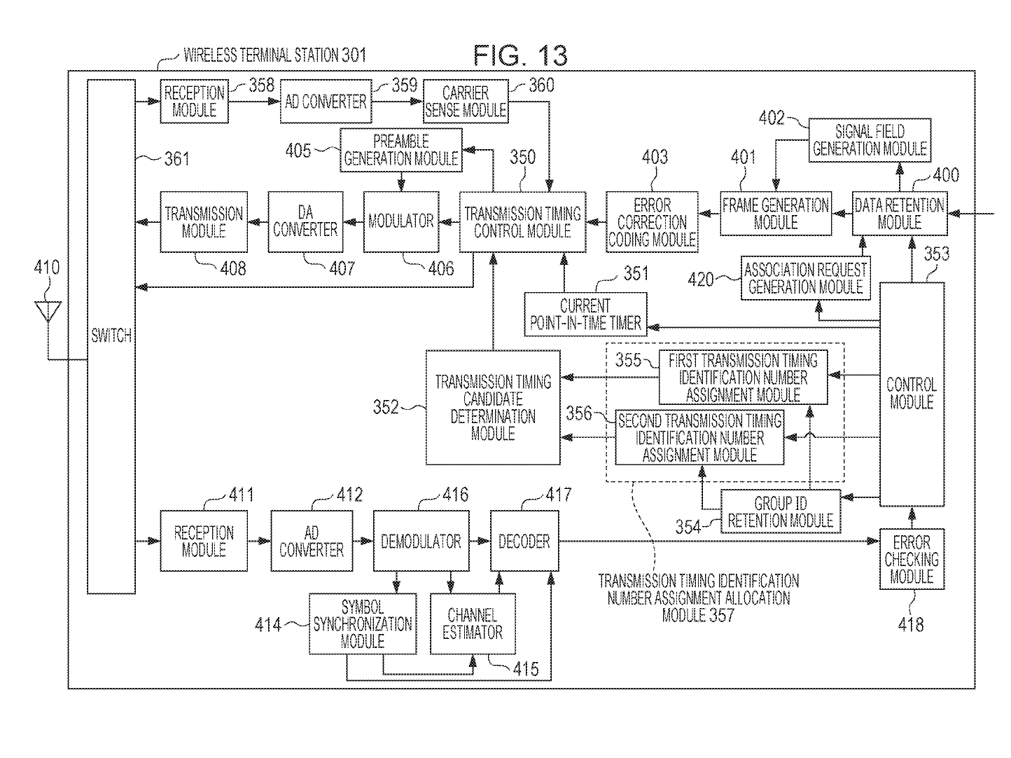

FIG. 13 is a functional block diagram illustrating one configuration example of the wireless terminal station 301 according to the present embodiment. Moreover, a function and a configuration of each of the wireless terminal stations 302 to 304 are assumed to be the same as those of the wireless terminal station 301.

The wireless terminal station 301 that is illustrated in FIG. 13 is configured from one antenna 410, a transmission module 408, a reception module 411, a DA converter 407, and AD converter 412, a modulation module 406, a preamble generation module 405, a transmission timing control module 350, an error correction coding module 403, a frame generation module 401, a signal field generation module 402, a data retention module 400, an association request generation module 420, a demodulator 416, a decoder 417, an error checking module 418, a symbol synchronization module 414, a channel estimation module 415, a control module 353, a group ID retention module 354, a first transmission timing identification number assignment module 355, a second transmission timing identification number assignment module 356, a transmission timing candidate determination module 352, a current point-in-time timer 351, a transmission timing control module 350, a reception module 358, an AD converter 359, a carrier sensing module 360, and a switch 361. The first transmission timing identification number assignment module 355 and the second transmission timing identification number assignment module 356 are collectively referred to as a transmission timing identification number assignment module 357.

The association request generation module 420 receives an instruction from the control module 353, and thus generates the association request. The data retention module 400 retains an information bit that is input. Furthermore, packet length information on the transmission frame is notified to signal field generation module 402 from the retained information bit.

The signal field generation module 402 generates a signal field that includes the packet length information which is notified from the data retention module 400, and inputs the generated signal field to the frame generation module 401. The frame generation module 401 generates a transmission signal frame that results from adding the signal field that is input from the signal field generation module 402, to a MAC frame to which an FCS field and the like are added, from the transmission data that is input from the data retention module 400.

The error correction coding module 403 performs error correction coding of the transmission signal frame to which the signal field that is input from the frame generation module 401 is added. The transmission timing control module 350 controls the transmission timing of the transmission signal frame that is transmitted by the error correction coding module 403. However, for transmission control of the association request, the DCF control in the related art is performed using the channel-used state that is notified from the carrier sensing module 360. Furthermore, in order to perform the carrier sensing for checking on the channel-used state of the channel that is used for the transmission, the transmission timing control module 350 instructs the switch 361 to connect the antenna 410 and the reception module 358 to each other. A control method relating to data transmission will be described in detail below.

According to an instruction from the transmission timing control module 350, the preamble generation module 405 generates a preamble that is added to the transmission signal frame that is retained in the transmission timing control module 350. The symbol synchronization field and the channel estimation field are included in the preamble.

The modulation module 406 performs OFDM modulation of a preamble field that is input from the preamble generation module 405, and continuously performs the OFDM modulation of the transmission frame that is input by the transmission timing control module 350.

The DA converter 407 performs the digital-to-analog (D/A) conversion of a digital signal that is input from the modulation module 406, into an analog signal. The transmission module 408 up-converts the baseband analog signal that is input, into a radio frequency band of the transmission signal, and outputs a result of the up-convert to the switch 361.

The switch 361 fundamentally has the same function as the switch 109 in FIG. 3, and connects the transmission module 108 or the reception module 358 and the antenna 410 to each other at a timing that is notified from the transmission timing control module 350. At timings other than this, the reception module 411 and the antenna 410 are connected to each other.

The reception module 358 down-converts the signal that is input, into a baseband, in order to perform the carrier sensing on a used state of a transmission band of the wireless terminal station 301. The reception module 411 down-converts the analog signal in a transmission frequency band of the base station 305, which is different from the transmission frequency band of the wireless terminal station 301, into the baseband.

The AD converter 359 AD-converts the signal that is input from the reception module 358, from an analog signal to a digital signal. In the same manner, the AD converter 412 A/D-converts the analog signal that is input by the reception module 411, into the digital signal. The carrier sensing module 360 checks on the channel-used state using the digital signal that is input from the AD converter 359.

The symbol synchronization module 414 detects the symbol synchronization field from the signal that is input from the AD converter 412, and gains the symbol synchronization. The channel estimator 415 extracts the channel estimation field from the signal that is input from the AD converter 412, at the timing that is notified from the symbol synchronization module 414, and performs the channel estimation.

The demodulator 416 demodulates the signal that is input from the AD converter 412 into the reception data using channel information that is obtained by the channel estimator 415 and the symbol synchronization timing that is obtained by the symbol synchronization module 414. The decoder 417 decodes the post-demodulation signal that is input from the demodulator 416 and generates the decoded information bit.

The error checking module 418 refers to the FCS field and the frame control field from the decoded information bit that is input by the decoder 417, and performs the checking of an error within the MAC frame. The control module 353 determines a type of reception data frame from the reception data that is input by the error checking module 418. With the type of receive frame, the control module 353 controls an operation in each functional block.

The group ID retention module 354 retains the group ID that is assigned to the wireless terminal station 301, from a group ID management frame that is input by the control module 353. Moreover, in a case where the group ID is newly input in a case where the group ID retention module 354 already retains the group ID, the group ID that is retained is assumed to be overwritten.

The first transmission timing identification number assignment module 355 and the second transmission timing identification number 356 assign the first transmission timing identification number and the second transmission timing identification number, respectively, using the group ID that is notified by the group ID retention module 354. A method of assigning two transmission timing identification numbers will be described below.

The transmission timing candidate determination module 352 determines at least one transmission starting timing, using the two transmission timing identification numbers (the first transmission timing identification number and the second transmission timing identification number) that are notified by the transmission timing identification number assignment module 357. A method of determining the transmission starting timing will be described below.

In a case where it is determined in the control module 353 that a beacon is received, the current point-in-time timer 351 gains the synchronization using a timing synchronization function (TSF) for gaining time synchronization, which is included in one beacon function.

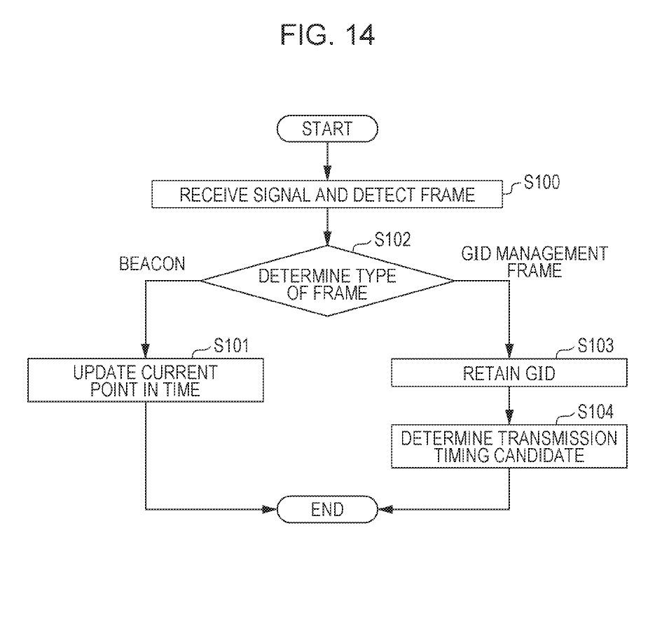

FIG. 14 is a flow chart for a period of time from when a signal is received from a base station 306 to when a type of reception signal frame is determined and thus processing is performed. However, an ACK signal that is received after the wireless terminal station 301 transmits the data frame, and the association response that is received after the association request is transmitted are not included in the reception signal. Furthermore, a method of performing processing that receives a frame that is illustrated in FIG. 14 is not particularly limited.

The wireless terminal station 301 receives a signal using the antenna 410, and detects a frame with the symbol synchronization module 414 (Step S100). The symbol synchronization field is detected, the data that is demodulated and decoded is input into the control module 353, the control module 353 determines a type of receive frame from the data that is input (Step S102). In a case where it is determined in Step S102 that the receive frame is a beacon, the current point-in-time timer 351 is notified of a beacon frame. The current point-in-time timer 351 gains the synchronization at a current point in time using the beacon frame that is input (Step S101).

In a case where it is determined in Step S102 that the receive frame is the group ID management frame, the control module 353 of the wireless terminal station 301 inputs group ID information into the group ID retention module 354 for retention (Step S103). However, in a case where the group ID is already retained, the group ID retention module 354 updates the group ID that is retained, with a new group ID that is input from the control module 353. The first transmission timing identification number assignment module 355 and the second transmission timing identification number assignment module 356 assign identification numbers, respectively, using the group ID that is input from the group ID retention module 354 (Step S109). A method of assigning the transmission timing identification number is not particularly limited, but for example, is determined using a remainder operation as illustrated in Equation 2.

For example, in a case where the number of integers that the first transmission timing identification number can take is N₁, a method of calculating the first transmission timing identification number is as expressed in Equation 6.

[Math. 6]

First transmission timing identification number=MS % N₁ Equation 6

where MS is a value that corresponds to a membership status in IEEE 802.11ac. In the same manner, in a case where the number of integers that the second transmission timing identification number can take is N₂, one example of a method of calculating the second transmission timing identification number is as expressed in Equation 7.

[Math. 7]

Second transmission timing identification number=STAP % N₂ Equation 7

where STAP is a value that corresponds to an STA position in IEEE 802.11ac.

With the method described above, the first transmission timing identification number and the second transmission timing identification number can be determined. However, in the same manner as with the first embodiment, a method of determining the transmission timing identification number is not particularly limited to this method.

The transmission timing candidate determination module 352 determines a transmission timing group that limits a period of time for the transmission timing, with the first transmission timing identification number, and determines the transmission starting timing within a time that is assigned to the transmission timing group, with the second transmission timing identification number.

Accordingly, because the transmission timing can be controlled in units of transmission timing groups, control is easily performed in an environment where the number of wireless terminal stations that are accommodated by the base station 305 is great.

One example will be described below in which the transmission timing candidate determination module 352 determines the transmission starting timing candidate that is obtained from the first transmission timing identification number and the second transmission timing identification number that are input from the transmission timing identification number assignment module 357.

In the same manner as with the first embodiment, in a case of IEEE 802.11a, the interval for the transmission starting timing is set to be an interval that is equal to or greater than the sum of times of predetermined ratios with respect to at least the symbol synchronization field length and the guard interval length for every transmission timing identification number. The transmission timing identification number in the format of IEEE 802.11ac will be described below.

With the first transmission timing identification number, the transmission timing group that limits a period of time for starting the transmission is determined. For example, in a case where a period of time for T[μs] is assigned to every transmission timing group, a period of time for starting the transmission is assigned according to a calculation equation such as Equation 8.

[Math. 8]

(current point in time/T)% N₁=first transmission timing identification number Equation 8

where an operator “%” means a remainder. Furthermore, Equation 9 is a floor function, and indicates an integer portion of real number A.

[Math. 9]

└A┘ Equation 9

For example, in a case where N₁=2 and T=1000, a limitation is imposed on the wireless terminal station that is assigned 0 as the transmission timing identification number in such a manner that the transmission starting timing is assigned during a period of time during which current point in time t[μs] satisfies 0≦t<1000, 2000≦t<3000, 4000≦t<5000, and so forth. In the same manner, a limitation is imposed on the wireless terminal station that is assigned 1 as the transmission timing identification number in such a manner that the transmission starting timing is assigned during a period of time during which current point in time t[μs] satisfies 1000≦t<2000, 3000≦t<4000, 5000≦t<6000, and so forth.

Next, a method of determining the transmission starting timing candidate using the second transmission timing identification number is described. For example, it is assumed that the transmission timing that has different interval Ta at every second transmission starting timing is determined with respect to a current point in time. However, as described above, according to the present embodiment, the interval for the transmission starting timing is set to be an interval that is equal to or greater than the sum of times of predetermined ratios with respect to at least the symbol synchronization field length and the guard interval length. The predetermined ratios are not particularly limited. Furthermore, a value that is a prime number of the OFDM symbol length is defined as Ta, and thus an effect of the MMSE adaptive array technology that uses the guard section of the signal which uses more of a cyclic prefix is obtained. For example, in a case where of IEEE 802.11a, the OFDM symbol length is 4 μs, the guard interval length is 0.8 μs, and a length of the STF that is the symbol synchronization field is 8 μs. In a case where a predetermined ratio is set to 1, interval Ta[μs] is at least 8.8 μs or above. Moreover, in order for interval Ta and OFDM symbol length 4 μs to be prime numbers, for example, Ta[μs]=9 may be established.

Transmission interval Ta that is set with the method describe above is used, and thus the transmission starting timing candidate can be calculated as in Equation 10.

[Math. 10]

Transmission timing=Ta×(N₂×y+second transmission timing identification number) Equation 10

where y in Equation 10 indicates an integer. To be more precise, in a case where limitations are imposed in such a manner that Ta[μs]=9 and N₂=2, and in such a manner that current point in time t[μs] as the transmission starting timing period satisfies 0≦t<1000, current point in time t[μs]=[0, 18, 36, and so forth up to 990] is established for the transmission starting timing of the wireless terminal station that is assigned 0 as the second transmission timing identification number. In the same manner, current point in time t[μs]=[9, 27, 45, and so forth up to 999] is established for the transmission starting timing of the wireless terminal station that is assigned 1 as the second transmission timing identification number.

With the method described above, the transmission timing candidate determination module 352 can determine the transmission starting timing candidate of the wireless terminal station 301. However, in the same manner as with the first embodiment, the method of determining the transmission starting timing candidate is not limited to this. If the transmission starting timing candidate that has a different second transmission timing identification number varies at a time interval that is at least a STF time which is the symbol synchronization field length or a predetermined ratio of a time with respect to the guard interval length, this may be sufficient. Furthermore, in order to improve the effect of the MMSE adaptive array technology that uses the guard section of more of a cyclic prefix, it is desirable that interval Ta of the transmission starting timing candidate is set to be a value that is a prime number of the OFDM symbol length.

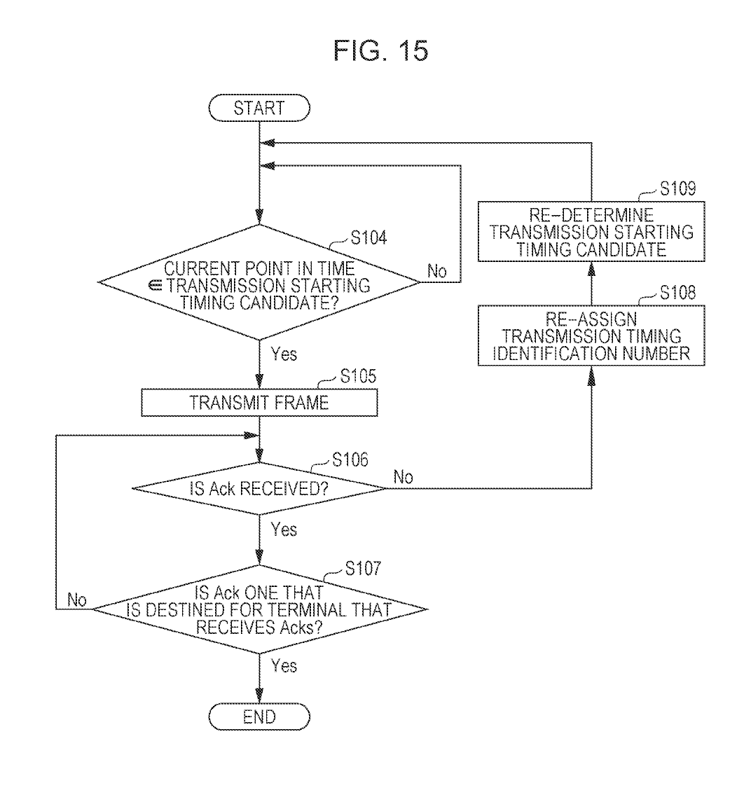

FIG. 15 is a flowchart for a period of time from when the wireless terminal station 301 transmits data to when the wireless terminal station 301 receives an ACK. If the transmission request occurs, the transmission timing control module 350 checks whether or not a current point in time of the current point-in-time timer 351 is included in the transmission starting timing candidate that is notified from the transmission timing candidate determination module 352 (Step S104). If in Step S104, the current point in time is a time that is included in the transmission starting timing candidate, the wireless terminal station 301 starts to transmit the transmission frame to which the preamble is added (Step S105). If the transmission of the transmission frame is ended, waiting for the ACK to be received is implemented for a predetermined time (Step S106). The predetermined time is equivalent to the SIFS time in IEEE 802.11.

If the ACK is received in Step S106, it is checked whether or not the received ACK is destined for the terminal that receives the ACKs (Step S107). In a case where in Step S106, the ACK is not received, it is determined that the transmission fails, and the control module 353 instructs the transmission timing identification number 357 to re-determine the transmission timing identification number (Step S108). In a case where with Equations 6 and 7, the transmission timing identification number is assigned, the transmission starting timing candidate is re-determined by changing values N₁ and N₂ (Step S109). A method of updating N₁ and N₂ is not particularly limited, but for example, a method of adding 1 to each of N₁ and N₂ and the like are employed.

In a case where in Step S107, the result is that the ACK that is destined for the terminal that receives the ACKs is received, the processing is ended. In a case where in Step S107, a signal is not a signal that is destined for the terminal that receives signals, waiting is implemented until the ACK is again received (Step S106).

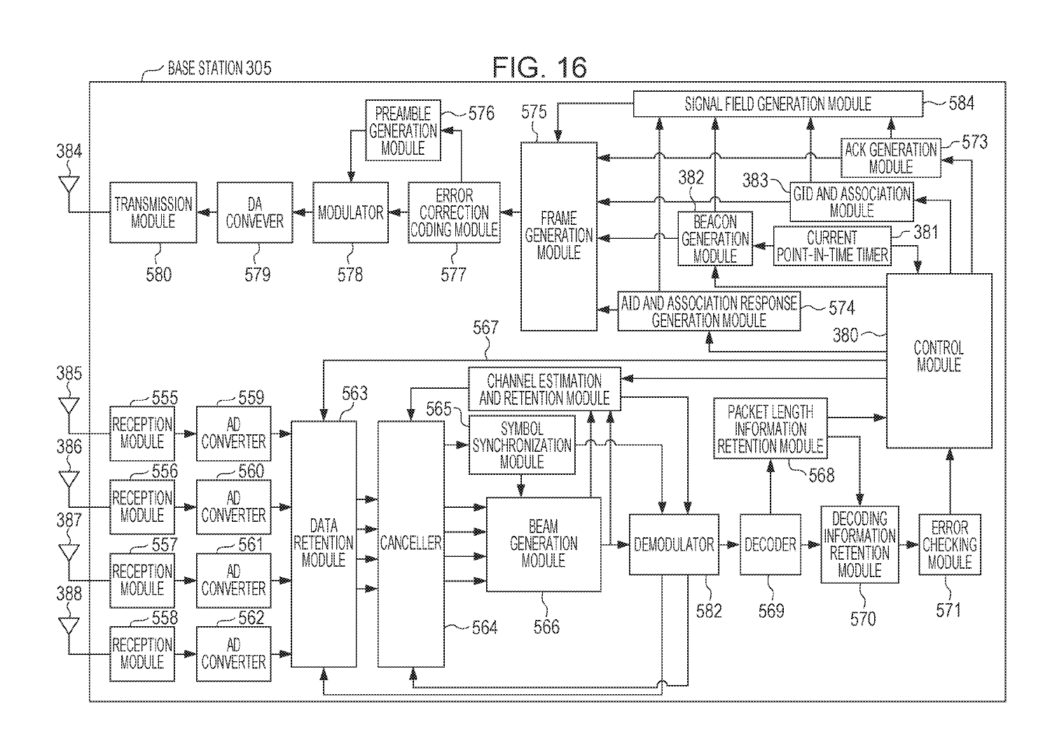

FIG. 16 is a functional block diagram illustrating one configuration example of the base station 305 according to the present embodiment. As illustrated in FIG. 16, the base station 305 is configured to include five antennas 384 to 388, four reception modules 555 to 558, four AD converters 559 to 562, a data retention module 563, a canceller 564, a symbol synchronization module 565, a beam generation module 566, a channel estimation and retention module 567, a demodulator 582, a packet length information retention module 568, a decoder 569, a decoding information retention module 570, an error checking module 571, an ACK generation module 573, an AID and association response generation module 574, a signal field generation module 584, a frame generation module 575, an error correction coding module 577, a preamble generation module 576, a demodulator 578, a DA converter 579, a transmission module 580, a control module 380, a current point-in-time timer 381, a beacon generation module 382, and a GID management generation module 383. Each functional block will be described below.

The antennas 385 to 388 input signals that are received into the reception modules 555 to 558, receptively. The reception modules 555 to 558 down-convert analog signals in radio frequency bands, which are transmitted from the wireless terminal stations 301 to 304 and which are input from the antennas 385 to 388, into a baseband, respectively. The AD converters 559 to 562 A/D-convert the analog signals that are input from the reception modules 555 to 558, into digital signals, respectively.

The data retention module 563 retains the digital signals that are input from the AD converters 559 to 562. The data retention module 563 can store pieces of data of the signals that are received from the antennas 385 to 388 as much as at least a maximum packet length. Furthermore, the data that is retained in the data retention module 563 is always updated with data that is input from the canceller 564. Furthermore, the data retention module 563 receives instructions from the control module 380, the symbol synchronization module 565, and the channel estimation and retention module 567, and thus inputs the data, which is retained, into the canceller 564.

The canceller 564 subtracts, from the signal that is input from the data retention module 563, a signal that results from multiplying a signal that results from re-modulating and re-decoding the information bit that is modulated and decoded in the previous processing, and the channel information. However, it is assumed that in the first processing, neither the information bit that is demodulated and decoded in the previous processing nor the channel information is present, and that the canceller 564 does not perform any processing.

The symbol synchronization module 565 performs the detection of the symbol synchronization field from the signal that is input by the canceller 564. The beam generation module 566 generates a beam of an MMSE adaptive array antenna that uses the guard section, from the signal that is input from the canceller.

The channel estimation and retention module 567 performs the estimation of the channel that is present before the beam is generated, using the channel estimation field that results after the beam that is input by the beam generation module 566 is generated, and weight, and retains a result of performing the estimation. After the channel information is estimated with the channel estimation field, the channel information that results after the beam which is used for the demodulation of an OFDM symbol that follows the channel estimation field is generated is estimated.

The demodulator 582 demodulates the channel information that results after the beam that is input from the channel estimation module 567 is turned, and the OFDM symbol that is input from the beam generation module 566. With demodulation decoding information in the signal field that is input from the decoder 569, the packet length information retention module 568 acquires and retains the packet length information. The decoder 569 decodes demodulation information that is input from the demodulator 582.

The decoding information retention module 570 continues to retain decoding information that is input from the decoder 569, to the extent of a packet length that is notified by the packet length information retention module 568. If the pieces of decoding information are accumulated in the decoding information retention module 570 to the extent of the packet length, the decoding information retention module 570 inputs the pieces of decoding information that are accumulated, into the error checking module 571.

The control module 380 performs the control of multiple functional blocks. In the same manner as with the control module 172 in FIG. 6, in the decoding demodulation processing, in a case where a notification is received from the decoder 569 in every decoding processing, and the packet length that is notified by the packet length information retention module 568 is not reached, an instruction is given in such a manner that a next field is output from the data retention module 563 to the canceller. The control module 380 checks on a current point in time with the current point-in-time timer 381, and instructs the beacon generation module 382 to generate a beacon. Furthermore, the control module 380 determines a type of reception signal from the information bit that is input from the error checking module 571. For example, in a case where the reception signal is the association request, the AID and association response generation module 574 is instructed to generate the association response, and the GID management generation module 383 is instructed to generate the group ID management frame.

The ACK generation module 573 receives an instruction from the control module 380 and receives the AID, and thus generates ACK information of the reception data. In the same manner, the AID and association response generation module 574 also receives the instruction from the control module 380 and sets the AID, and thus generates the association response that includes AID information.

The signal field generation module 584 acquires the packet length information from the ACK generation module 573 or the AID and association response generation module 574, and generates the signal field that includes the packet length information.

The current point-in-time timer 381 counts a point in time that serves as a reference for the current points in time of all the wireless terminal stations that are present in a service area of the base station 305. When receiving an instruction from the control module 380, the beacon generation module 382 generates the beacon that includes current point-in-time information. The frame generation module 575 generates a transmission MAC frame from pieces of information that are input from the ACK generation module 573 or the AID and association response generation module 574, and generates the transmission signal frame to which the signal field that is input from the signal field generation module 584 is added.

The error correction coding module 577 performs the error correction coding of the transmission signal frame that is input from the frame generation 575. The preamble generation module 576 receives an instruction from the error correction coding module 577, and thus generates the preamble that is added to the transmission signal frame that is input to the error correction coding module 577.

The demodulator 578 modulates the information bit that is input, and the DA converter 579 performs the D/A conversion of the digital signal that is input from the demodulator 578, into the analog signal. The transmission module 580 up-converts the analog signal that is input from the DA converter 579, into the transmission frequency. An instruction is received from the control module 380, and thus a connection is switched. Like the wireless terminal station 301, the base station 305 is assumed to perform the data exchange or to perform the error detection in units of frames. The antenna 384 starts transmit the analog signal that is input from the transmission module 580.

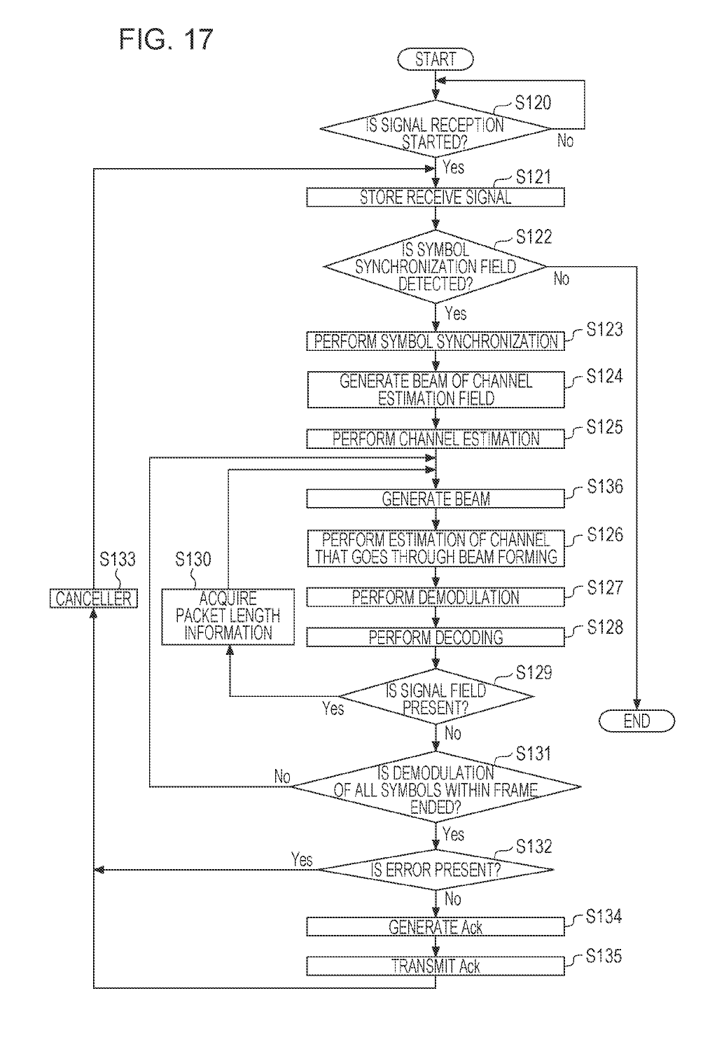

FIG. 17 is a flowchart for a period of time from when the base station 305 starts to receive a signal to when the base station 305 starts the demodulation of data and transmits the ACK. The base station 305 waits until signals are received in the antennas 385 to 388 (Step S120). If the signals begin to be received, the signals that are input in the antennas 385 to 388 are stored in the data retention module 563 through the reception modules 555 to 558 and the AD converters 559 to 562, respectively (Step S121).

The signal that is stored in the data retention module 563 is input into the symbol synchronization module 565 through the canceller 564. The symbol synchronization module 565 detects the symbol synchronization field from the signal that is input (Step S122). In a case where in Step S122, the symbol synchronization field is not detected in all signals that are stored in the data retention module 563, the processing is ended.

In a case where the symbol synchronization field is detected in Step S122, the symbol synchronization module 565 gains the symbol synchronization (Step S123), and notifies the data retention module 563, the beam generation module 566, and the demodulator 582 of timing of the symbol synchronization.

Subsequent to the symbol synchronization (Step S123), the channel estimation field passes through the data retention module 563 and the canceller 564, and a beam of the channel estimation field is generated in the beam generation module 566 (Step S124). A method of generating the beam of the channel estimation field is the same as in the first embodiment. If the generation of the beam of the channel estimation field (Step S124) is ended, the channel information is estimated in the channel estimation and retention module 567 (Step S125). However, the channel information that is estimated in the channel estimation and retention module 567 is channel information of a desired signal that is present before the weight is applied.

If the channel estimation (Step S125) is ended, a beam is generated in the beam generation module 566 using a signal subsequent to the channel estimation field (Step S136). As described above, if the processing that is to be performed the predetermined number of repetitions is ended, the beam generation module 566 notifies the channel estimation and retention module 567 of the weight.

The channel estimation and retention module 567 estimates the channel information that is used in the demodulator 582, from the weight that is input from the beam generation module and from the channel information that is retained (Step S126). The channel information that goes through the beam formation and that is estimated in the channel estimation and retention module 567 is input into the demodulator 582. The demodulator 582 demodulates the OFDM symbol that is input from the beam generation module 566, based on the channel information that is input from the channel estimation and retention module 567 (Step S127).

Next, the decoder 569 performs the decoding of the OFDM symbol that is input from the demodulator 582, and the decoded OFDM symbol is stored in the decoding information retention module 570 (Step S128).

The decoder 569 determines from a type of the immediately-preceding field whether or not the decoded signal is a signal field (Step S129), and in a case where the type is the signal field, acquires the packet length information from the decoding information (Step S130) and inputs the acquired packet length information into the packet length information retention module 568. If the packet length information is acquired, the demodulation processing of data subsequent to the signal field is started (Step S136).

The packet length information retention module 568 notifies the decoding information retention module 570 and the control module 380 of the packet length that is notified from the decoder 569. In a case where it is determined in Step S129 that a decoded signal is not the signal field, the control module 380 and the decoding information retention module 570 checks, from the packet length notified from the packet length information retention module 568, whether or not the demodulation and the decoding of all OFDM symbols that are included in the packet are ended (Step S131).

In a case where all the OFDM symbol is not demodulated and decoded in Step S131, the control module 380 starts the demodulation processing of a next OFDM symbol (Step S136). In Step S131, if the demodulation and the decoding of the all OFDM symbols within the packet are confirmed, the decoding information retention module 570 inputs the pieces of decoding information into the error checking module 571 in a manner that corresponds to one packet. The error checking module 571 performs the error checking from the decoding information that is input (Step S132).

If an error is not confirmed in Step S132, the ACK generation module 573 generates an ACK according to an instruction from the control module 380 (Step S134). If the error is confirmed in Step S132, the control module 380 instructs the data retention module 563 to input the retained data into the canceller 564.

If the ACK is generated (Step S134), the base station 305 transmits and transmits an ACK frame (Step S135). If the ACK is transmitted (Step S135), the data retention module 563 receives an instruction from the control module 380, and thus again inputs the retained data into the canceller 564.

The canceller 564 subtracts, from a signal that is input from the data retention module 563, a signal that results from multiplying the channel information that is retained in the channel estimation and retention module 567, and a signal that results from re-coding and re-modulating the information bit that is input from the decoding information retention module 570. With the method described above, the canceller 564 performs cancel (Step S133). Furthermore, a signal that is canceled in the canceller 564 is overwritten as data of the data retention module.

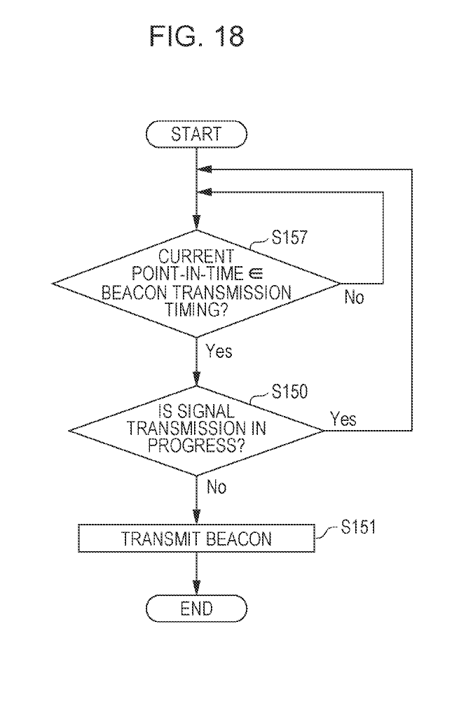

FIG. 18 is a flowchart illustrating that the base station 305 transmits the beacon. The control module 380 checks on a current point in time in the current point-in-time timer 351, and checks whether or not the current point in time is a point in time at which the beacon is transmitted (Step S157). In a case where in Step S157, the current point in time is not the point in time at which the beacon is transmitted, waiting is implemented until a beacon transmission timing.

In a case where in Step S157, the result is that the current point in point is the point in time at which the beacon is transmitted, the base station 305 checks whether or not transmission of a current signal is in progress (Step S150). In a case where in Step S150, the transmission of the current signal is in progress, returning to Step S157 takes place. In a case where in Step S150, the result is that the transmission of the signal by the base station 305 is not in progress, the control module 380 instructs the beacon generation module 382 to generate the beacon. The beacon frame, the beacon for which is generated, is transmitted (Step S151).

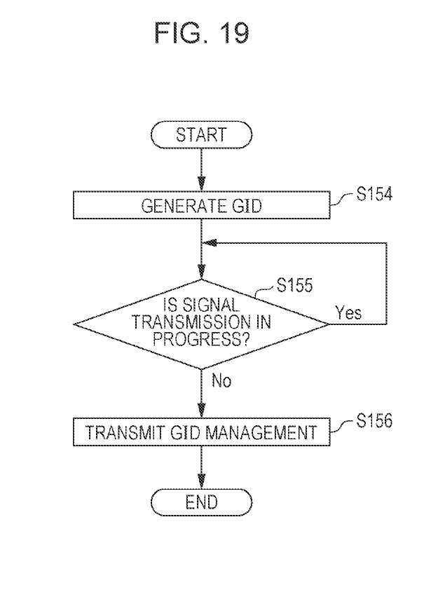

FIG. 19 is a flowchart for a period of time from when a group ID is generated to when a group ID management frame is transmitted. The base station 305 generates the group ID (Step S154). However, a generation timing of the group ID is not particularly limited, and after at least association is established, the base station 305 generates the group ID for the wireless terminal station that establishes the association.

If the group ID is generated (Step S154), it is checked whether or not the transmission by the terminal that receives the ACKs is in progress (Step S155). If the transmission is not in progress, the group ID management frame is transmitted (Step S156). Communication as in the timing chart in FIG. 12 can be realized by using the wireless terminal station 301 that is illustrated in FIG. 13, the wireless terminal stations 302 to 304 that have the same function as the wireless terminal station 301, and the base station 305 that is illustrated in FIG. 16.

According to the present embodiment, each of the wireless terminal stations 301 to 304 performs the transmission control, such as starting the transmission based on the current point-in-time timer that each of the wireless terminal stations has and on the identification number that is assigned to each of the wireless terminal stations, and thus the uplink communication can be efficiently performed with the MMSE adaptive array that uses the guard section of the signal which uses the cyclic prefix.

Possible aspects of the present invention are as follows.

(1) A wireless communication method for use in a wireless terminal station that is applied to a wireless communication system which is made up of multiple wireless terminal stations and a base station, includes a step of setting a delay time based on a transmission timing identification number, and a step of starting transmission has elapsed from a point in time at which transmission has started in a case where any other wireless terminal station starts the transmission within a predetermined time after all communication within the wireless communication system has ended.

(2) Furthermore, a wireless communication method for use in a wireless terminal station that is applied to a wireless communication system which is made up of multiple wireless terminal stations and a base station, includes a step of setting a delay time based on a transmission timing identification number, and a step of starting transmission after the delay time has elapsed from a point in time at which communication has ended, in a case where any other wireless terminal station within the wireless communication system ends the communication.

(3) Furthermore, a wireless communication method for use in a wireless terminal station that is applied to a wireless communication system which is made up of multiple wireless terminal stations and a base station, includes a step of setting a transmission starting point in time based on a transmission timing identification number, and a step of starting transmission at the transmission starting point in time that is set.

(4) Furthermore, among the transmission timing identification numbers, a step of determining a transmission timing group using a first transmission timing identification number, and of setting the transmission-starting point in time within a period of time that is assigned to the transmission timing group, using a second transmission timing identification number may be included.

(5) Furthermore, in a base station that is applied to a wireless communication system which is made up of multiple wireless terminal stations and a base station, among the multiple wireless terminal stations, at least one wireless terminal station transmits information that is used for determining a transmission timing identification number which is used to control a transmission timing, to the wireless terminal station.

With this configuration, because data transmission timing differs from one wireless terminal to another, it is possible to effectively perform demodulation using an MMSE adaptive array that uses a guard section of a signal that uses a cyclic prefix.

A program running on the wireless terminal station and the base station according to the present invention is a program (a program for causing a computer to operate) that controls a CPU and the like in such a manner as to realize the function according to the embodiment of the present invention. Then, pieces of information that are handled in these devices are temporarily stored in a RAM while being processed. Thereafter, the pieces of information are stored in various ROMs or HDDs, and whenever necessary, is read by the CPU to be modified or written. As a recording medium on which to store the program, among a semiconductor medium (for example, a ROM, a nonvolatile memory card, and the like), an optical storage medium (for example, a DVD, a MO, a MD, a CD, a BD, and the like), a magnetic storage medium (for example, a magnetic tape, a flexible disk, and the like), and the like, any one may be possible.

Furthermore, in some cases, the functions according to the embodiments described above are realized by running the loaded program, and in addition, the functions according to the present invention are realized by performing processing in conjunction with an operating system or other application programs, based on an instruction from the program. Furthermore, in a case where programs are distributed on the market, the programs, each of which is stored on a portable recording medium, can be distributed, or the program can be transmitted to a server computer that is connected through a network such as the Internet. In this case, a storage device of the server computer is also included in the present invention.

Furthermore, some of or all of the portions of the wireless terminal station and the base station according to the embodiments described above may be realized as an LSI that is a typical integrated circuit. Each functional block of the wireless terminal station and the base station may be individually realized into a chip, and some of, or all of the functional blocks may be integrated into a chip. Furthermore, a technique of the integrated circuit is not limited to the LSI, and an integrated circuit for the functional block may be realized with a dedicated circuit or a general-purpose processor. Furthermore, if with advances in a semiconductor technology, a circuit integration technology with which an LSI is replaced appears, it is also possible to use an integrated circuit to which such a technology is applied.

### REFERENCE SIGNS LIST

1 TO 4 WIRELESS TERMINAL STATIONS

5 BASE STATION

100 DATA RETENTION MODULE

101 FRAME GENERATION MODULE

102 SIGNAL FIELD GENERATION MODULE

103 ERROR CORRECTION CODING MODULE

104 TRANSMISSION TIMING CONTROL MODULE

105 PREAMBLE GENERATION MODULE

106 MODULATION MODULE

107 DA CONVERTER

108 TRANSMISSION MODULE

109 SWITCH

111 RECEPTION MODULE

112 AD CONVERTER

113 CARRIER SENSING MODULE

114 SYMBOL SYNCHRONIZATION MODULE

115 CHANNEL ESTIMATOR

116 DEMODULATOR

117 DECODER

118 ERROR CHECKING MODULE

119 CONTROL MODULE

120 ASSOCIATION REQUEST GENERATION MODULE

121 AID RETENTION MODULE

122 TRANSMISSION TIMING IDENTIFICATION NUMBER ASSIGNMENT MODULE

123 DELAY TIME SETTING MODULE

151 TO 154 ANTENNAS

155 TO 158 RECEPTION MODULES

159 TO 162 AD CONVERTERS

163 DATA RETENTION MODULE

164 CANCELLER

165 SYMBOL SYNCHRONIZATION MODULE

166 BEAM GENERATION MODULE

167 CHANNEL ESTIMATION AND RETENTION MODULE

168 PACKET LENGTH INFORMATION RETENTION MODULE

169 DECODER

170 DECODING INFORMATION RETENTION MODULE

171 ERROR CHECKING MODULE

172 CONTROL MODULE

173 ACK GENERATION MODULE

174 AID AND ASSOCIATION RESPONSE GENERATION MODULE

175 FRAME GENERATION MODULE

176 PREAMBLE GENERATION MODULE

177 ERROR CORRECTION CODING MODULE

178 MODULATION MODULE

179 DA CONVERTER

180 TRANSMISSION MODULE

181 SWITCH

182 DEMODULATOR

183 CARRIER SENSING MODULE

184 SIGNAL FIELD GENERATION MODULE

200 TO 203 Head GI ACQUISITION MODULES

204 MMSE MODULE

205 ARRAY COMBINATION MODULE

206 Tail GI ACQUISITION MODULE

207 CONTROL MODULE

301 TO 304 WIRELESS TERMINAL STATIONS

305 BASE STATION

350 TRANSMISSION TIMING CONTROL MODULE

351 POINT-IN-TIME TIMER

352 TRANSMISSION TIMING CANDIDATE DETERMINATION MODULE

353 CONTROL MODULE

354 GROUP ID RETENTION MODULE

355 FIRST TRANSMISSION TIMING IDENTIFICATION NUMBER ASSIGNMENT MODULE

356 SECOND TRANSMISSION TIMING IDENTIFICATION NUMBER ASSIGNMENT MODULE

357 TRANSMISSION TIMING IDENTIFICATION NUMBER ASSIGNMENT MODULE

358 RECEPTION MODULE

359 AD CONVERTER

360 CARRIER SENSING MODULE

361 SWITCH

380 CONTROL MODULE

381 CURRENT POINT-IN-TIME TIMER

382 BEACON GENERATION MODULE

383 GID MANAGEMENT GENERATION MODULE

384 TO 388 ANTENNAS

400 DATA RETENTION MODULE

401 FRAME GENERATION MODULE

402 SIGNAL FIELD GENERATION MODULE

403 ERROR CORRECTION CODING MODULE

405 PREAMBLE GENERATION MODULE

406 MODULATION MODULE

407 DA CONVERTER

408 TRANSMISSION MODULE

410 ANTENNA

411 RECEPTION MODULE

412 AD CONVERTER

414 SYMBOL SYNCHRONIZATION MODULE

415 CHANNEL ESTIMATOR

416 DEMODULATOR

417 DECODER

418 ERROR CHECKING MODULE

420 ASSOCIATION REQUEST GENERATION MODULE

555 TO 558 RECEPTION MODULES

559 TO 562 AD CONVERTERS

563 DATA RETENTION MODULE

564 CANCELLER

565 SYMBOL SYNCHRONIZATION MODULE

566 BEAM GENERATION MODULE

567 CHANNEL ESTIMATION AND RETENTION MODULE

568 PACKET LENGTH INFORMATION RETENTION MODULE

569 DECODER

570 DECODING INFORMATION RETENTION MODULE

571 ERROR CHECKING MODULE

573 ACK GENERATION MODULE

574 AID AND ASSOCIATION RESPONSE GENERATION MODULE

575 FRAME GENERATION MODULE

576 PREAMBLE GENERATION MODULE

577 ERROR CORRECTION CODING MODULE

578 DEMODULATOR

579 DA CONVERTER

580 TRANSMISSION MODULE

582 DEMODULATOR

584 SIGNAL FIELD GENERATION MODULE

1. A first wireless terminal station that is applied to a wireless communication system which is made up of multiple wireless terminal stations and a base station, comprising:
a delay time setting module that sets a first delay time based on a first transmission timing identification number;
a carrier sensing module that detects that a second wireless terminal station included in the wireless communication system and different from the first wireless terminal station has started transmission; and
a transmission module that starts transmission after the first delay time has elapsed from a point in time at which the second wireless terminal station has started the transmission after all frame transmission completion within the wireless communication system has ended.

2. A wireless terminal station that is applied to a wireless communication system which is made up of multiple wireless terminal stations and a base station, comprising:
a delay time setting module that sets a delay time based on a transmission timing identification number;
a carrier sensing module that detects that; and
a transmission module that starts transmission after the delay time has elapsed from a point in time at which the second wireless terminal station has ended frame transmission.

3. A wireless terminal station that is applied to a wireless communication system which is made up of multiple wireless terminal stations and a base station, comprising:
a transmission timing candidate determination module that sets a transmission starting point in time based on a transmission timing identification number; and
a transmission module that starts transmission at the transmission starting point in time that is set.

4. The wireless terminal station according to claim 3,
wherein, among the transmission timing identification numbers, the transmission timing candidate determination module determines a transmission timing group, using a first transmission timing identification number, and sets the transmission starting point in time within a period of time that is assigned to the transmission timing group, using a second transmission timing identification number.

5. A base station that is applied to a wireless communication system which is made up of multiple wireless terminal stations and a base station,
wherein, among the multiple wireless terminal stations, at least one wireless terminal station transmits information that is used for determining a transmission timing identification number which is used to control a transmission timing, to the wireless terminal station.

6. The first wireless terminal station according to claim 1,
wherein the first delay time is longer than a second delay time set to a third wireless terminal station.

7. The first wireless terminal according to claim 1,
wherein a second timing identification number is assigned to an apparatus of a fourth wireless terminal station included in the communication system other than the first wireless terminal station, and at least a method of acquiring first timing identification information is different from a method of acquiring the second timing identification number.
